(19) United States
(12) Patent Application Publication
(10) Pub. No.: US 2025/0078189 A1
(43) Pub. Date: Mar. 6, 2025

(54) TOKENIZATION PROTOCOL FOR PHYSICAL COMMODITY OWNERSHIP TRANSFER

(71) Applicant: EL-DAR AL-KHASSEH LTITWER AL-OMRANI Ltd., Jeddah (SA)

(72) Inventors: Essam Fakieh, Jeddah (SA); Ahmed A. Fadol, Washington, DC (US)

(21) Appl. No.: 18/809,195

(22) Filed: Aug. 19, 2024

Related U.S. Application Data
(60) Provisional application No. 63/535,828, filed on Aug. 31, 2023.

(51) Int. Cl. G06Q 50/16; G06Q 20/06; G06Q 30/02

(52) U.S. Cl. CPC G06Q 50/167; G06Q 20/0658; G06Q 30/0278; G06Q 2220/00

(57) ABSTRACT

Described is a system for physical commodity ownership transfer by receiving a first physical commodity ownership record document for a physical commodity, generating fractionalized property tokens corresponding to a value of the physical commodity, and transmitting the generated fractionalized property tokens to a tokenized account associated with the physical commodity holder. The system receives a first token resource allocation by a first physical commodity acquirer, determines a first number of fractionalized property tokens corresponding to the value of the first token resource allocation, transmits the first number of fractionalized property tokens from the tokenized account associated with the physical commodity holder to the tokenized account associated with the first physical commodity acquirer, and generates a second physical commodity ownership record document indicating fractional ownership by the physical commodity holder and the first physical commodity acquirer.

### CLAIM OF PRIORITY

This patent application claims the benefit of U.S. Provisional Patent Application No. 63/535,828, filed Aug. 31, 2023, entitled “Tokenization Protocol for Physical Commodity Ownership Transfer”, which is incorporated by reference herein in its entirety.

### TECHNICAL FIELD

The present disclosure relates generally to a tokenization system, and more specifically to physical commodity division and tokenization.

### BACKGROUND

Traditional home ownership often involves acquiring a mortgage from a financial institution like a bank or a mortgage lender. In this setup, an aspiring homeowner, upon finding a suitable property, applies for a mortgage loan. The lender evaluates the applicant's creditworthiness based on their financial history, current income, and debt levels, among other factors. If the application is approved, the lender provides the funds necessary to purchase the home, and the homebuyer agrees to repay the loan over a predefined period, typically in monthly installments over 15 to 30 years. The property serves as collateral, which means that if the borrower fails to make the required payments, the lender has the right to take possession of the home (foreclosure) and sell it to recover their funds. Over time, as the homebuyer makes their mortgage payments, they gradually build equity in the home, which represents their financial stake or ownership interest in the property. When the loan is fully repaid, the lender releases the lien to the deed, indicating full ownership to the home buyer.

### BRIEF DESCRIPTION OF THE SEVERAL VIEWS OF THE DRAWINGS

In the drawings, which are not necessarily drawn to scale, like numerals may describe similar components in different views. To identify the discussion of any particular element or act more easily, the most significant digit or digits in a reference number refer to the figure number in which that element is first introduced. Some non-limiting examples are illustrated in the figures of the accompanying drawings in which:

FIG. 1 illustrates an architecture for tokenizing of a real estate asset, according to some examples.

FIG. 2 illustrates an architecture comparing conventional mortgage and rental systems with the tokenization system regarding ownership of the property over time, according to some examples.

FIG. 3 illustrates an architectural diagram between the tokenization system, asset owners, and individuals, according to some examples.

FIG. 4 illustrates an example method 400 for a tokenization protocol for physical commodity ownership transfer, according to some examples.

FIG. 5 illustrates an architectural diagram of tokenized asset ownership transfer, according to some examples.

FIG. 6 illustrates ownership transfer for a collection of physical commodities, according to some examples.

FIG. 7 illustrates collaborative tokenization of physical commodities for ownership transfer, according to some examples.

FIG. 8 is a diagrammatic representation of a machine in the form of a computer system within which a set of instructions may be executed to cause the machine to perform any one or more of the methodologies discussed herein, according to some examples.

FIG. 9 is a block diagram showing a software architecture within which examples may be implemented.

FIG. 10 illustrates a machine-learning pipeline, according to some examples.

FIG. 11 illustrates training and use of a machine-learning program, according to some examples.

FIG. 12 illustrates tokenization of an asset as a whole, according to some examples.

FIG. 13 illustrates tokenization of an asset that is divisible into parts, according to some examples.

FIG. 14 illustrates tokenizing ownership and/or usage across time, according to some examples.

FIG. 15 illustrate tokenizing ownership and/or usage across time and parts, according to some examples.

FIG. 16 illustrates tokenization for use allocations, according to some examples.

FIG. 17 illustrates token generation based on location, according to some examples.

FIG. 18 illustrates token generation for copies of goods, according to some examples.

### DETAILED DESCRIPTION

Traditional real estate and mortgage systems have several significant drawbacks that make them less effective for today's dynamic environment. Traditional mortgage systems are generally rigid and inflexible and do not easily adjust to changing circumstances of homeowners, making them prone to risk. If homeowners encounter financial difficulties, the homeowners may default on their mortgage payments, leading to foreclosure and loss of their investment.

Traditional real estate systems often require a substantial down payment (usually around 20% of the property's value). This high upfront cost, coupled with the ongoing financial risk of mortgage payments, discourage many prospective homeowners from investing in real estate.

Moreover, the process of selling property in traditional real estate systems is time-consuming and complicated, making real estate an illiquid asset. The traditional real estate systems do not provide options for individuals who need quick access to cash.

Real estate transactions often involve numerous intermediaries and extensive paperwork. This complexity can lead to inefficiencies, delays, mistakes, and high transaction costs, including realtor fees, closing costs, notary fees, and other administrative charges.

The complex nature of real estate transactions in traditional real estate systems can lead to fraudulent activities such as double spending, selling disputed properties, or fraudulent alterations to property deeds. This creates mistrust and uncertainty in the market, deterring potential investors.

Traditional methods of transferring ownership in traditional real estate systems are often complex and time-consuming, requiring coordination among multiple parties. Any missteps or delays can lead to significant disruptions and potential legal issues.

In traditional asset ownership, the risk is predominantly placed on the asset owner. If the asset's value decreases, or if the owner's financial situation changes, the owner bears the brunt of the financial impact. Moreover, the lender takes a very large risk of default by underwriting a mortgage for a substantial portion of the property's value to the purchaser.

Traditional systems do not provide a mechanism for fractional ownership of properties. This means that investors with limited funds cannot participate in the real estate market, even if they are interested in investing.

Traditional systems lack the flexibility to adapt to changing circumstances. For instance, there is no straightforward mechanism for property owners to sell a portion of their property to relieve financial stress, nor for investors to acquire a small fraction of a property that aligns with their investment capacity.

When property owners have several properties or when multiple owners collaborate, managing these properties becomes a significant challenge. Dividing profits, determining ownership percentages, and coordinating property management are complex tasks that could lead to conflicts and inefficiencies.

In cases where multiple investors or property owners are involved, the traditional system's distribution of dividends or rent proceeds can be complex and inefficient. It often requires an extensive audit trail and paperwork, which increases administrative costs and the potential for errors.

Traditional systems are often bounded by local or regional restrictions, making it difficult for investors from different geographical locations to invest in properties. This limits the pool of potential investors and restricts the global growth of the real estate market.

Examples of the tokenization system as described herein mitigate and/or eliminate the pitfalls of traditional systems as described above. The tokenization system described herein overcomes these challenges by offering a flexible, transparent, efficient, and cost-effective alternative to traditional real estate transactions and mortgage systems.

The tokenization system provides an innovative and flexible solution to the drawbacks of traditional asset management and real estate systems, and in some cases, leveraging the power of blockchain technology to divide the ownership of an asset into multiple tokens.

In the tokenization process, the system begins by evaluating the value of the property or asset. The asset owner submits a legal document (such as a deed) that proves ownership rights of the asset to the system. Once the value is determined, the tokenization system generates a specified number of tokens that collectively represent the total value of the asset. This process essentially breaks down the ownership of the asset into smaller, manageable pieces that can be bought, sold, or traded.

One major benefit of the tokenization system is that it allows for partial ownership of assets. The owner of the asset can choose to sell the property by selling the corresponding tokens. This tokenized exchange can involve a single buyer purchasing all the tokens, or multiple buyers each purchasing a proportion of the tokens. This fractional ownership facilitates lower entry barriers and increases liquidity, thereby expanding access to real estate investments.

In cases where an owner possesses multiple properties or when several owners collaborate, the tokenization system can create tokens equivalent to the total value of all the properties. Tokens can be distributed based on the value of each property or the percentage of ownership across the multiple properties. This way, each property owner can receive their share of proceeds in accordance with their individual ownership stakes.

The tokens can be sold on the open market, allowing anyone interested to purchase a portion of the asset or property. This democratizes the real estate investment process by permitting anyone, regardless of their geographical location or financial status, to participate in the market.

The tokenization system also streamlines the process of dividend and rent proceed distributions. Instead of complex traditional methods, the proceeds can be easily distributed based on the number of tokens each party holds, simplifying the process and ensuring transparency and accuracy.

Additionally, the tokenization system leverages blockchain technology, which provides a transparent and immutable record of all transactions. This significantly reduces the potential for fraudulent activities and enhances trust among participants in the market.

The tokenization system lowers the barrier of entry by enabling fractional ownership. A buyer can invest in real estate by purchasing a portion of the total tokens that represent the asset's value, thereby reducing the need for substantial initial capital.

The tokenization system transforms these assets into easily tradable tokens. Investors can buy and sell tokens on open markets, providing quick access to cash and making real estate a more liquid investment.

The tokenization system eliminates the need for many of the intermediaries required in traditional systems by using blockchain technology, thus reducing the costs, complexity, and time required for transactions. Moreover with tokenization, the risk is spread among a larger pool of token holders, which helps protect individual investors from substantial losses.

The tokenization system leverages the immutable and transparent nature of blockchain technology, making all token transactions publicly visible and auditable, reducing the risk of fraud. Furthermore, the tokenization system allows for both sole and shared ownership. An owner can choose to sell tokens to a single buyer or multiple buyers, enabling flexible and tailored ownership structures. The tokenization system also makes this process straightforward and efficient by distributing proceeds based on the number of tokens each party holds.

When the effects in this disclosure are considered in aggregate, one or more of the methodologies described herein may improve known systems, providing additional functionality (such as, but not limited to, the functionality mentioned above), making such systems easier, faster, or more intuitive to operate, and/or obviating a need for certain efforts or resources that otherwise would be involved in the tokenization process. Computing resources used by one or more machines, databases, or networks may thus be more efficiently utilized or even reduced.

### Tokenization of Asset

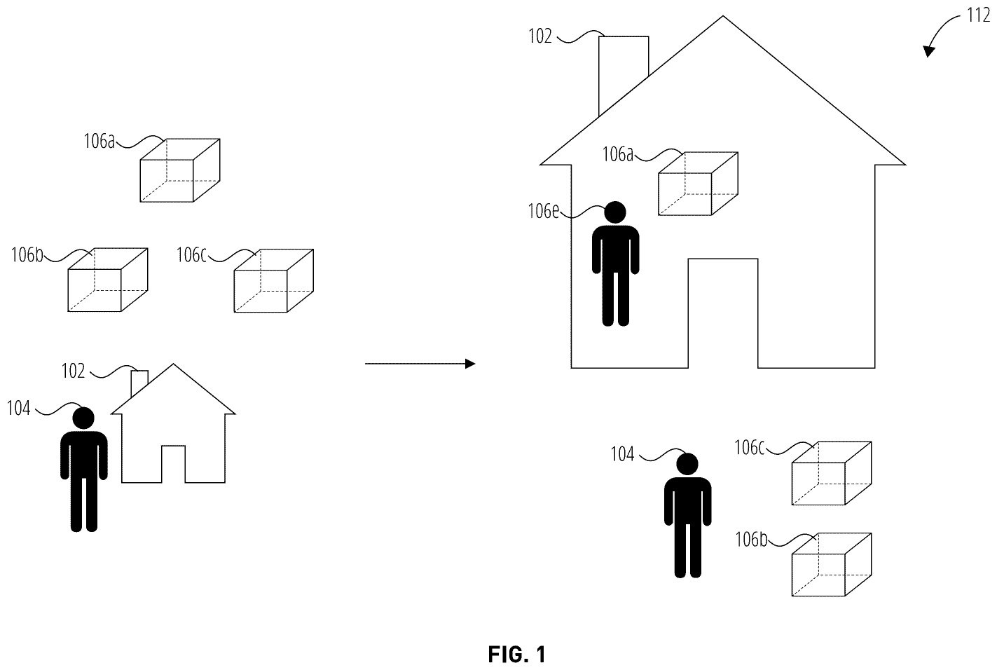

FIG. 1 illustrates an architecture 112 for tokenizing of a real estate asset, according to some examples. The process of tokenizing a home or an asset by the tokenization system can be described into several steps.

One step is for the tokenization system to evaluate the property to determine its current market value. In some cases, the tokenization system employs technological methods for estimating the value of a property. In some cases, the tokenization system compares the property to similar properties in the same area that have been sold recently by retrieving data from third party real estate databases.

In some cases, the tokenization system applies a regression analysis that can determine how different variables (like location, size, age, number of rooms, and nearby amenities) impact the property's value. The algorithm is trained on a vast dataset of property sales to learn the weight of each variable.

In some cases, the tokenization system applies Geographic Information System (GIS) data, which includes geographical and topological data about a property and its surroundings. The tokenization system applies this data to assess the value based on physical features like proximity to water bodies, hills, parks, and more.

In some cases, the tokenization system applies one or more artificial neural networks to predict property values. The neural network is trained on a large dataset and can handle complex, non-linear relationships between variables (such as data related to the property and other similar assets), making the estimate more accurate.

Although artificial intelligence, neural networks, and machine learning models are disclosed as performing certain features, it is appreciated that a machine learning model can be trained and applied by the tokenization system to perform any or all of the features of the tokenization system as described herein. For example, a first machine learning model facilitates decisioning by the tokenization system between modules and other machine learning models, whereas a second machine learning model generates a prediction of property values.

Systems and methods described herein include training a machine learning network, such as training to generate smart contracts, predict property values, mint tokens, facilitate transactions to various individuals and wallets, perform features on deeds and ownership, and/or the like. The machine learning network can be trained to perform one or more of the features for the tokenization system as described herein.

The machine learning algorithm can be trained using historical information. For example, the machine learning model is trained to generate smart contracts by applying historical real estate transactions for use cases on the tokenization system, resulting in self-executing smart contracts which are deployed on the blockchain (e.g., sent to the blockchain network and stored on the distributed ledger).

Training of models, such as artificial intelligence models, is necessarily rooted in computer technology, and improves modeling technology by using training data to train such models and thereafter applying the models to new inputs to make inferences on the new inputs. Here, the new inputs can be information relating to a new homeowner requesting tokenization of the home to rent and slowly sell the home to a new tenant. The trained machine learning model performs the various features of enabling the homeowner to tokenize the home and enable the new tenant to progressively own the home.

Such training involves complex processing that typically requires a lot of processor computing and extended periods of time with large training data sets, which are typically performed by massive server systems. Training of models can require logistic regression and/or forward/backward propagating of training data that can include input data and expected output values that are used to adjust parameters of the models.

Such training is the framework of machine learning algorithms that enable the models to be applied to new and unseen data (such as new tenant or asset owner data) and make predictions that the model was trained for based on the weights or scores that were adjusted during training. Such training of the machine learning models described herein reduces false positives and increases the performance.

Once the property value is established, the homeowner submits a digital version of the deed to the tokenization system. This deed serves as a legal proof of ownership and will be held by the tokenization system for the duration of the rental agreement.

Using the property's evaluated value and a particular value for each token (whether a predefined value or current market value), the tokenization system determines a number of tokens to be minted. For example, if a home 102 of FIG. 1 is valued at $300,000 and each token is worth $100,000, the system mints 3 fractionalized property tokens 106a, 106b, 106c (collectively referred to herein as fractionalized property tokens 106). These tokens are digital representations of ownership in the property.

The tokenization system mints new tokens on the blockchain or distributed ledger by creating new digital tokens or coins. First, the tokenization system generates a smart contract and is deployed to the blockchain. This contract serves as the blueprint for the new tokens and contains rules about how the tokens can be transferred, how many will exist, and other necessary specifications.

Once the smart contract is live, the blockchain invokes the smart contract to mint new tokens. When the mint function is called, a specified number of tokens are created and assigned to the specified owner's address. In this case, an asset owner 104 is assigned as the owner of the fractionalized property tokens 106 representing full ownership of the home 102. As the minted tokens are then awarded to the homeowner, the tokenization system effectively converts the physical commodity into a digital form of ownership that can be divided, sold, or traded.

Although the examples described herein explain blockchain technology, digital ledger technology, tokens, and/or smart contracts to apply to particular examples, it is appreciated that the features of the tokenization system can be applied to other blockchains, tokens, and/or smart contracts. For example, blockchain technology can be applied to predict property values, and mint tokens, whereas smart contracts can be applied to facilitate a transaction (such as a payment) to various individuals and wallets, perform features on deeds and ownership, and/or the like.

The advent of blockchain technology, tokenization, and/or smart contracts improve trusts in the tokenization system using various features rooted in technology. Blockchain technology ensures that once a transaction is recorded on the blockchain, it can't be changed. In the context of the tokenization system, once the owner receives tokens corresponding to their property's value, that transaction is recorded permanently. The same goes for each token that a tenant purchases. This creates a clear, immutable record of who owns the asset, making the system much more trustworthy.

Moreover, every transaction on the blockchain is visible to all network participants. This means that the process of tokenization, as well as each subsequent token purchase, is completely transparent. No one can secretly change the number of tokens or alter the value of the asset, because such a change would be visible to everyone on the network.

The decentralized nature of blockchain also contributes to its trust worthiness. Rather than relying on a single entity (like a bank or government) to verify transactions, blockchain uses a network of nodes (computers). Each node has a copy of the blockchain, and transactions are verified through a consensus process. In essence, multiple parties agree on the validity of transactions, making it virtually impossible for fraudulent activity to occur.

The tokenization system can use smart contracts to facilitate one or more processes of the tokenization system. The tokenization system writes (or a machine learning model automatically generates) smart contracts to automatically perform features of the tokenization system as described herein, such as transferring tokens from the tenant to the owner upon receipt of a transaction (such as a payment), and transferring ownership of the asset once all tokens have been purchased. Smart contracts execute automatically when certain conditions are met, and because they're also stored on the blockchain, they're transparent, immutable, and verifiable.

Tokenization of asset ownership, such as in the case of real estate, provides enhanced security and privacy in several ways. With the blockchain or similar decentralized technology that underlies tokenization, there's no central authority holding all the data. This makes it harder for cybercriminals to exploit a single point of failure.

Moreover, once a transaction is recorded and confirmed on the blockchain, it can't be altered or tampered with. This prevents any fraudulent changes to the ownership records. Every token can be tracked from its inception, offering a clear and indisputable lineage of ownership.

Blockchain uses strong cryptographic algorithms to ensure the data in the blockchain can only be read by those involved in the transaction. This means personal and financial data can be securely stored and transferred. The tokenization system applies cryptography to tokenize real estate or any asset on a blockchain. In some cases, the tokenization system applies a public-key (asymmetric) cryptography using pairs of keys: public keys (which may be known to others), and private keys (which are known only to the owner).

The generation of such keys depends on cryptographic algorithms based on mathematical problems to produce one-way functions. The owner of the private key can use the key to sign transactions or data, and anyone with the public key can verify the signature. In the context of blockchain tokenization, the ownership of tokens (and therefore the real estate) can be proven by the possession of the private key.

The tokenization system includes a hash function, which given an input, produces a fixed size string of bytes. Every transaction in a blockchain can be hashed and the hash value is stored in the block. Any change in the transaction data would change the hash, which can easily be checked. These hash functions ensure data integrity.

When a token owner wants to transfer their tokens (representing ownership or equity in a real estate property), the token owner can create a transaction and sign it with their private key. This digital signature proves that the transaction was created by the actual owner and was not tampered with. Anyone can verify the signature with the corresponding public key, but they cannot forge the signature without the private key.

In some cases, the tokenization system encrypts sensitive data using the public key which can only be decrypted using the corresponding private key. This means even if someone else gets hold of this encrypted data, they can't read or understand it without the private key.

These cryptographic features and algorithms of the tokenizing system underpin the security, trust, and immutability aspects of the asset-backed tokens that represent equity in the asset. Such use of keys improves data security by restricting unauthorized use, view, and/or recordation of data onto the tokenization system.

These keys are used to authenticate users to data (such as ownership) or transactions (such as a request to tokenize a physical commodity) which increases security, prevents unauthorized access by third parties, and enables users of the tokenization system to apply features in an easily implemented way. Moreover, such encryption features are necessarily rooted in computer technology.

With tokenization, personal details can be kept private while still proving ownership. Rather than sharing all of your personal information, a token representing ownership can be transferred while your personal data stays secured.

The tokenization system applies smart contracts which are self-executing contracts embedded with the terms of the agreement directly written into code and/or onto the distributed ledger. The smart contracts permit trusted transactions and agreements to be carried out among disparate parties without the need for a central authority, legal system, or external enforcement mechanism.

Traditional transactions typically involve intermediaries, such as banks or transaction processors, that have access to all transaction data. With blockchain technology, transactions are made directly between parties, which means that sensitive data, such as transaction information, isn't exposed to third-party companies. This reduces the risk of sensitive data being intercepted or misused.

In summary, through the use of blockchain and tokenization, you can create a secure, transparent system for real estate ownership and transactions that minimizes the risk of fraud, protects privacy, and enhances the security of sensitive data.

A tenant rents the property and, in addition to paying rent, begins to purchase tokens from the homeowner. These transactions can be made separately or as part of the rent payment. Over the duration of the lease (or tenure), the tenant can acquire one or more tokens, such as fractionalized property token 106a, thereby gaining a portion of ownership in the property.

As the tenant begins to acquire tokens, the proceeds or dividends from the property are divided among the token holders based on their percentage of ownership. In the given example, if the tenant has acquired one fractionalized property token 106a, the tenant would receive ⅓ of the proceeds, while the homeowner would receive ⅔. The proceeds to the tenant can be less than ⅓ of the rent as the proceeds can be determined by subtracting expenses from the rent (such as insurance, property tax, property management). The homeowner could get more than ⅔ if the homeowner is the one performing property management.

This technical method of tokenization enables gradual transfer of ownership from the homeowner to the tenant and provides both parties with more flexibility and liquidity than traditional systems. It also allows for a more seamless and efficient real estate transaction process, reducing the need for intermediaries and reducing costs.

The tokenization system uses a combined order of specific procedures that tokenizes real world properties that represent ownership, and these tokens are used in a variety of different and novel ways as described herein. Not only do some examples and features of the tokenization system eliminate the need for intermediaries that are typical in the home purchasing process, the process of the tokenization system is also different than the process for traditional systems.

The tokenization does not simply automate traditional systems and concepts. By leveraging tokenization technology, the tokenization system enables efficiencies and improvements to the real estate world, such as by leasing of ownership and partial ownership, progressive ownership as a tenant using the property, deed recordation and ownership facilitation, other features of the ownership tokens, and/or the like.

### Conventional Mortgage and Rental Compared with Tokenization System Regarding Ownership Over Time

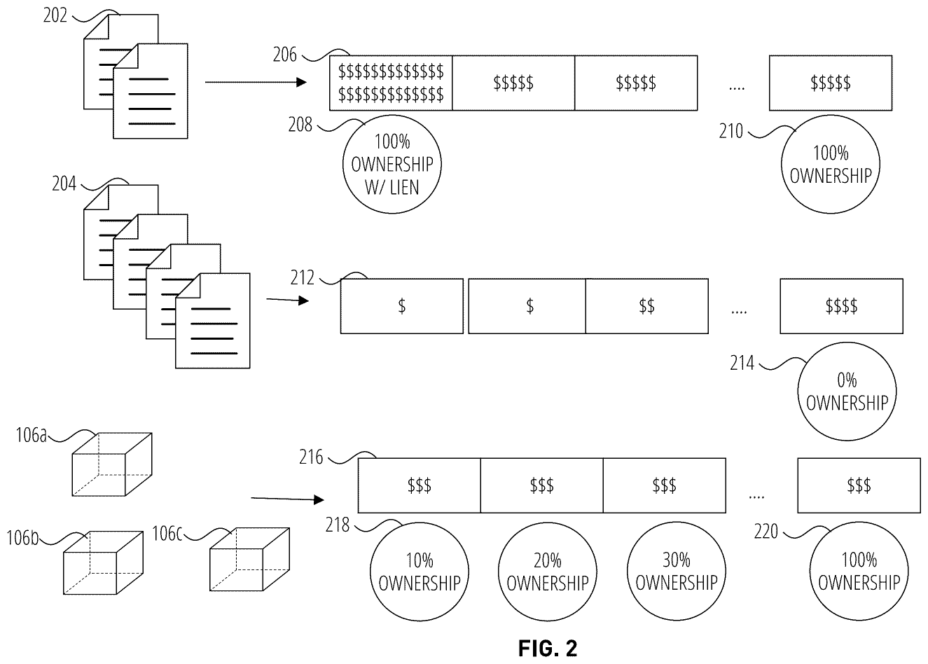

FIG. 2 illustrates an architecture comparing conventional mortgage and rental systems with the tokenization system regarding ownership of the property over time, according to some examples.

In a conventional mortgage system, the homebuyer typically pays a large down payment 206, often 20% of the home's value, and borrows the remaining 80% from a bank or other lending institution. The homebuyer gets legal 100% ownership of the property through a deed, but the lender also has a lien on the property (100% ownership with a lien 208), meaning they can foreclose and take possession if the homebuyer fails to make mortgage payments. The deed 202 is provided to the new buyer.

Integration with land record databases—The system could interface directly with public land records to submit lien documents for recording and retrieve confirmation. In some cases, the tokenization system implements self-executing smart contracts that automatically notifies relevant third party databases that have their own record (such as records of liens and ownerships), transfer lien-related assets, and/or record the lien on the blockchain upon meeting coded conditions.

In some cases, the tokenization system applies IoT sensors, such as sensors on deed documents could track their physical location and confirm when they are processed by the registrar's office. In some cases, the tokenization system applies computer vision algorithms, such as scanning deed documents and verifying registrar stamps and signatures using OCR and image analysis to validate recording (such as lien recording). In some cases, the tokenization system applies web scrapers to scrap public land record sites to check for lien recording and confirm registration details.

In some cases, the tokenization system applies Application Programming Interfaces (API) that interface with registrar's office databases, and submit via API lien data and retrieve recording confirmation of lien recordation programmatically. In some cases, the tokenization records the lien on a distributed ledger, such as recording the lien cryptographically on a blockchain to decentralized ledger.

Over the term of the loan, which could be 15 to 30 years, the homebuyer pays off the borrowed amount along with interest. The interest payments can significantly increase the total amount the homebuyer pays for the home. However, throughout this period, the homebuyer gradually gains equity in the home with each mortgage payment the homebuyer makes, and once the mortgage is fully paid, the homebuyer owns the home outright with 100% ownership 210 without a lien.

When a tenant rents a property, a contract 204 is signed between the tenant and the property owner that includes rental terms. The tenant pays a set amount 212 each month for the use of the property but gains no ownership or equity. Moreover, the rent could increase as time passes. This is typically the least costly option in the short term, as the tenant only pays for the use of the property and don't have to provide a large upfront down payment or pay interest. However, at the end of the lease, the tenant has 0% ownership 214 in the property, and all the money the tenant paid in rent does not contribute to any form of property ownership.

In contrast, the tokenization system combines elements of both mortgages and rentals while leveraging the advantages of tokenization technology. When the tenant uses this tokenization system, the tenant starts renting the property and also purchases fractionalized property tokens 106 over time. Each token represents a fraction of ownership in the property. Each month, the tenant makes payments 216 for the rental of the property and also for the tokens. The tenant gradually builds equity in the property (such as 10% ownership 218 initially) without needing to provide a large down payment upfront or pay high amounts of interest to a lender. Over time, and as leases renew, the tenant accumulates enough tokens to own the property outright at 100% ownership 220 without any liens and risks of default. The tokenization system provides the flexibility to move without the need to sell property, given that the tokens can be sold, transferred, and/or held. The tenant also has the ability to acquire ownership over time, thereby making homeownership more accessible for more people.

### Architectural Diagram Between the Tokenization System, Asset Owners, and Individuals

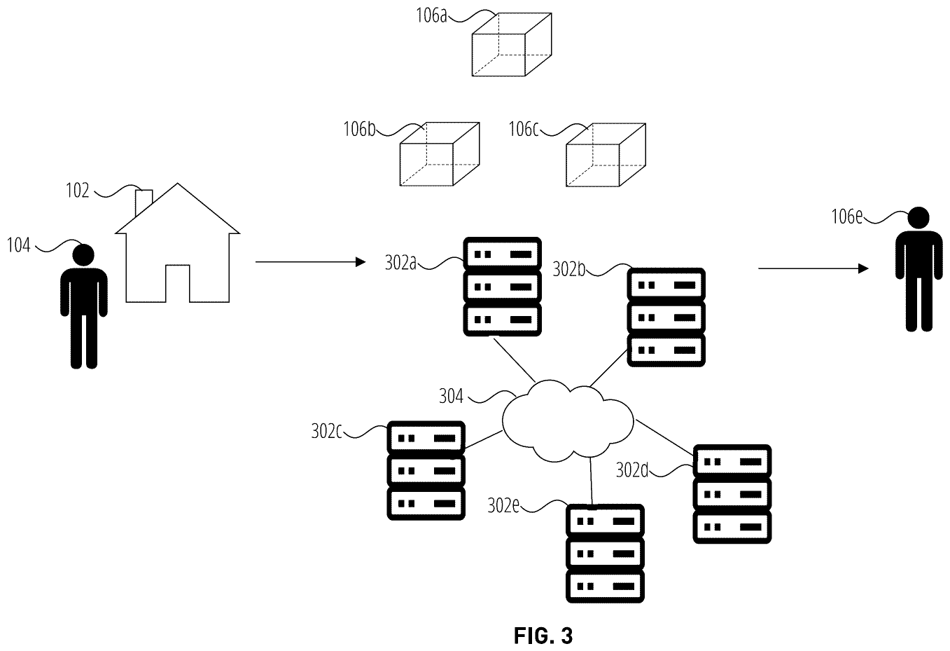

FIG. 3 illustrates an architectural diagram between the tokenization system, asset owners, and individuals, according to some examples. A group of computers 302a, 302b, 302c, 302d, and 302c (collectively referred to as the group of computers 302) connected to the Internet 304 runs the blockchain that forms a decentralized network, also known as nodes in blockchain terminology. These nodes are responsible for maintaining and updating the blockchain ledger, which in this case performs actions that record ownership, transactions, and contractual terms, and execute smart contracts for real estate properties.

When an asset owner 104 wants to tokenize their home 102, the asset owner submits the necessary documentation (such as a deed) to the tokenization system. The tokenization system receives a digital deed and performs functions using one or more forms of artificial intelligence, data processing, and cryptographic technologies.

The tokenization system receives a digital copy of the deed from the asset owner. This digital copy could be a scanned document or a photo of the physical deed. The tokenization system performs Optical Character Recognition (OCR), which can be a form of Artificial Intelligence (AI) that identifies text within digital images or scanned documents. The OCR module converts the visual representation of the text in the digital deed into machine-readable text.

Once the text has been recognized, a Natural Language Processing (NLP) module can be used to identify and extract key pieces of information. NLP, which can be another form of AI, is capable of understanding human language. In this case, the tokenization system identifies information such as the owner's name, the property description, boundaries, and any relevant legal language.

The extracted information is then standardized and stored in a structured database, enabling easy access and comparison. Standardization may involve transforming the text to conform to set formats, such as converting dates to a YYYY-MM-DD format, or geolocating addresses to standardized coordinates. Information, such as a digital copy of a deed, received from the various data sources can be of a different format.

In some cases, the machine learning model classifies the property based on the extracted information. The machine learning model identifies certain characteristics of the property that is not explicitly in the extracted information. For example, the machine learning model classifies a unit as a 1 bedroom based on its size and location.

The tokenization system configures data from multiple different databases that are in their own non-standardized format into a single standardized format. As such, messages can be automatically generated to communicate with individuals such as tenants and asset owners using the standardized format. Moreover, assessments and decisioning made by the tokenization system can be applied back to the asset owner by reapplying non-standardized formatting of the asset owner.

In some cases, the tokenization system processes the deed information into a viewable form, such as in a way which mirrors the physical representation of an original paper form of the deed. This reduces the time consuming nature of importing source code into the form. The tokenization system converts a digital copy of the deed into a standardized form which establishes calculations and rule conditions required to fill in the standardized form, import data from the digital copy to populate data fields in the standardized form, and performs calculations on the imported data. This allows the tokenization system to change imported data into a standardized viewable form.

In some cases, the tokenization system applies such standardization on documents or data received and/or documents generated. The tokenization system generates a standardized form of a deed to enable the tokenization system to generate a viewable deed form. In some cases, the tokenization system generates contracts, such as between the tenant and the asset owner, to rent and purchase tokens. The tokenization system collects data related to the tenant, asset owner, and asset from various different sources and applies standardization to this data to populate fields of the generated documents (e.g., contracts).

In some cases, the machine learning model performs one or more features of the standardization described herein. In some cases, the machine learning model performs customizations and/or standardizations based on a user's preferences. For example, the user inputs preferences such as a particular language for translation, customization on classifications and associated parameters, non-linear transformation, and/or the like.

In some cases, the tokenization system cross-checks information from the deed against a government or public property database. The tokenization system accesses such data via an API (Application Programming Interface) to interface with the relevant public records databases, query the extracted details, and compare the results for verification purposes. This step ensures that the property details match the official records and that the person claiming ownership is indeed the legal owner.

In some cases, the tokenization system and/or machine learning model cross-checks such information from the deed using other third party database. For example, the tokenization system checks information using global positioning system (GPS) data to verify the location, accesses photographs or data of prior owners such as on social media to verify the interior design of the home, and/or assesses a live camera feed from an augmented reality device. For example, the live camera feed can include a walk through of the property and the machine learning model applies computer vision algorithms to the camera feed to identify characteristics of the home, such as door types, bedroom locations, size, and/or the like.

Although the machine learning model is described to perform certain steps herein, it is appreciated that the machine learning model can facilitate and/or perform one or more features of the tokenization system, such as asset valuation, generation of tokens, transmitting of tokens from one wallet to another, providing usage to an asset user, and/or the like.

Once the ownership is verified, the tokenization system divides the property's value into multiple tokens, as per the value evaluated by the system or provided by the user. The property can be divided based on a ratio of the value of the physical commodity and the value for each token. These tokens represent fractional ownership in the property. The token ownership records, deed, and other relevant details are encrypted and stored on a blockchain. Each token transfer can be managed via a smart contract, ensuring that all transactions are secure, transparent, and immutable, and the tokens are made available for tenants to purchase.

In some cases, the tokenization system applies the API to perform a recordation on the property records database, such as a records database of a government entity. In some cases, the tokenization system records a lien on the property based on tokens minted for the property.

In some cases, the tokenization system creates internal property records. For example, the tokenization system uses these internal property records for a layer of protection (e.g., to prevent multiple entries). In some cases, the tokenization system creates an internal property record to not have to rely on public records and/or to rely on such internal records when public records are unavailable.

If the tenant becomes the full owner, the tokenization system facilitates the transfer of ownership. The tokenization system initiates a transaction via the API with the property records database, to record the new ownership, such as via a smart contract indicating full ownership. These operations are conducted securely due to the cryptographic principles of the underlying blockchain and/or tokenization technology.

In some cases, the features related to the deed and/or other features of the tokenization system applies a self-referential table. A self-referential table includes a database table where a foreign key references the primary key of the same table. The tokenization system, for example, applies such self-referential tables to track the ownership history of the tokens representing asset ownership.

Each token could be represented as a row in the table, with fields such as token_id (the primary key), current_owner, previous_owner, and originating_asset (or depositor). The previous_owner field could reference another row in the same table, indicating the previous owner of the token before the current token owner, forming a chain of ownership. Such fields can be recorded onto the digital ledger. The tokenization system uses the originating_asset to associate a token with other tokens minted by the same asset owner. Advantageously, this field helps for certain features of the tokenization system, such as exchangeability and fungibility.

When a token is transferred from one owner to another (e.g., from the asset owner to a tenant), the current_owner field of the token's row is updated with the new owner's ID. A new row is also added to the table, representing a new token owner. The previous_owner field of this new row points to the row representing the token that was just transferred, creating a link in the chain of ownership.

Moreover, the tokenization system tracks a history of ownership via the self-referential table through the previous_owner field. Starting from a row representing a token's current owner, and previous_owner fields that would lead to the previous token owners before the current owner, and so on, until a row is reached where previous_owner is null, indicating the original token issued to the asset owner. This traceability adds to the transparency and security of the system, as it provides a tamper-proof log of token ownership changes.

When tokens are resold back to the asset owner or moved to another property, a similar process to the token transfer can be followed. The current_owner of the affected tokens is updated, and new rows are added to represent the new token owners.

The self-referential tables can include a special row and/or column within the database that stores the pointers to the other portions of the same table or other tables. Instead of having to save the benefit characteristics for each of the transactions or individuals, the tokenization system includes an entry that refers to another portion of the table or other table with the corresponding information. Advantageously, the data stored in each of the databases can be reduced by calling a call function (e.g. a database pointer) when a certain data entry in another table is needed.

Thus, a tokenization system and/or client devices can perform functions of the tokenization system and have more flexibility in assessing large datasets, which previously required a large network throughput of data and high processing speed. Moreover, a self-referential table can enable more efficient storage and retrieval of larger sized data, faster searching of the asset ownership, token distribution, and/or the like; and more flexibility in configuring the database.

In some cases, the tokenization system includes the group of computers 302 and/or facilitates communication among the group of computers 302. The nodes in the network validate information, such as ownership, and if validated, the nodes initiate the token creation process. The value of the property is divided by the chosen token value to determine the number of tokens to be minted.

These fractionalized property tokens 106, representing fractional ownership of the property, are issued to the asset owner (such as a tenant), such as to the asset owner's virtual asset storage. The transaction of minting and assigning these tokens is recorded on the ledger.

The nodes (such as the blockchain nodes) also manage the buying, selling, and leasing of tokens. For instance, when a tenant wants to buy tokens from an owner, the tenant submits a transaction to the network. The nodes verify the transaction, make sure the tenant has sufficient funds, and transfer the tokens from the owner's virtual asset storage to the tenant's. Once the transaction is validated and confirmed by the network (e.g., via the nodes), the transaction is recorded on the blockchain.

If a tenant accrues enough tokens to fully own the property, the blockchain network facilitates the transfer of ownership. The nodes of the blockchain burn or delete the tokens and update the property's ownership status on the digital ledger. The nodes validate this transaction before recording it on the blockchain. The nodes facilitate transfer over of the deed to the tenant.

When an asset owner (homeowner) decides to tokenize their property, the tokenization system evaluates the property to determine its current market value. The homeowner then provides the system with the necessary documentation (such as a copy of the deed) to confirm ownership of the property.

This information is verified by the decentralized network of computers running the blockchain, such as by accessing real estate records of ownership and/or on its own ledger of real estate ownership records. Once the information has been verified and the property's value has been established, the system will proceed with the tokenization process.

The value of the property is divided by the chosen token value (e.g., if a $300,000 property is divided into tokens each worth $100,000, 3 tokens will be minted as described above). These tokens, representing fractional ownership of the property, are digitally minted on the blockchain and assigned to the homeowner's virtual asset storage.

If a new tenant moves in or a lease is renewed, the system adjusts the valuation. if the value of the property increases, a certain number of additional tokens are minted and provided to the asset owner and/or the token holders associated with the property.

The homeowner may request to the tokenization system a re-evaluation of the property's value at any point, such as after significant improvements or renovations (e.g., adding a pool). If the value has changed, the system could initiate a re-tokenization process. For instance, if the property's value has increased from $300,000 to $500,000 and the token value remains at $100,000, two additional tokens would be minted and assigned to the homeowner and/or the token holders. This re-tokenization is recorded on the digital ledger.

Tokenizing real estate assets allows for flexibility in buying, selling, and transferring the tokenized assets. Individuals can trade tokens on a peer-to-peer basis on the tokenization platform, which is supported by the blockchain network. If a tenant wishes to buy tokens, they can send a transaction request to another individual who owns the tokens. The nodes verify ownership of the token and payment, and facilitate the transfer of ownership for the token.

The buyer sends the agreed upon amount (often in a form of cryptocurrency or any acceptable payment method on the platform) to the seller. Upon confirmation of payment, a smart contract is executed that transfers the tokens from the seller's virtual asset storage to the buyer's wallet. This transaction is recorded and verified on the blockchain, providing an immutable record and ensuring transparency.

In some cases, a buyer can buy or sell tokens directly from/to the asset owner. The asset owner lists the tokens for sale on the platform (such as with the specified price). A buyer who wishes to buy these tokens sends a purchase request, pays the specified price, and receives the tokens upon confirmation of payment via a smart contract. The smart contract ensures payment is made and tokens are owned and transferred. The asset owner can also buy back the tokens from the tenant or another token holder using a similar process.

Blockchain technology's inherent transparency, security, and immutability make it well-suited for this kind of application. Each node in the network independently verifies every transaction and maintains a copy of the ledger, making the system highly resilient and reliable. This decentralization also ensures that no single entity has control over the network, increasing trust and participation in the system using technological advances that are not typically used in real estate, let alone real estate ownership scenarios.

Intermediaries such as property developers or token aggregators could hold a pool of tokens from various properties and offer them for sale to interested buyers. The intermediary can list the tokens for sale on the platform, and buyers can purchase these tokens.

Intermediaries also can buy tokens. For instance, a token aggregator might be interested in buying tokens from various individual holders to add to their collection. Individual token holders or asset owners could sell their tokens to these intermediaries following a similar transaction process as described herein.

In these scenarios, the use of smart contracts ensures that transactions are securely executed and recorded. The blockchain's decentralized nature ensures transparency, as all transactions are visible to all participants in the network.

In some cases, the tokenization system and/or a smart contract can facilitate the use of a property. For example, a tenant can be renting a home while obtaining tokens. The tokenization system can facilitate such use by sending a message to control the property. The tokenization system sends a wireless message to a lockbox on the property enabling the user to access keys to open the home. In some cases, such messages can control the use, type of use, availability of certain operations and features, time period and duration of use, and/or the like using these communications.

The tokenization system sends such signals to a computing device or server of the asset, such as a vehicle computing device or a server communicating with one or more smart home systems.

In some cases, depending on the rules set by the platform, tokens are used across properties, meaning a token holder could potentially use their tokens as payment to rent or purchase in another property on the platform. These features make the tokens of the tokenization system truly fungible and provide additional flexibility to the token holders.

In the context of tokenizing real estate, leasing tokens introduces a level of flexibility and unique opportunities for temporary ownership and use of assets. The tokenization system enables a token holder who owns a certain percentage of an asset to lease tokens to another individual. By doing so, the tokenization system enacts a smart contract that enables the other individual to gain temporary ownership of the tokens and, by extension, the right to use or benefit from a proportion of the asset represented by these tokens.

During the lease period, the tokenization system enables the temporary token holder to rent the property to a tenant. The proceeds from the tenant are received by the tokenization system, whereby smart contracts are invoked to provide the proceeds to the token holder and the temporary token owner. At the end of the lease, the tokenization system invokes a smart contract whereby the tokens are automatically returned to the token owner's wallet.

The distribution of rent proceeds automatically disperse via smart contracts. For instance, if the rent is paid in cryptocurrency, the smart contract automatically distributes the rent to the token owner, the temporary token owner, and property manager based on predefined percentages. For example, the property manager may require a certain amount or percentage of the proceeds.

Token leasing in this manner not only provides opportunities for passive income for token holders but also increases liquidity of the token in the token market. It further allows those without the capital to purchase tokens outright to benefit from tokenized assets temporarily.

Token holders in a real estate tokenization system have various investment strategies at their disposal. The token holders can engage in arbitrage, where they buy and sell tokens to take advantage of price discrepancies across different markets or platforms, turning a profit from the difference in token prices. This might occur if tokens representing the same asset are priced differently in distinct markets.

Token holders can adopt a long-term investment strategy, holding onto tokens to benefit from natural appreciation of the underlying real estate asset. In some cases, over time, as the property value increases, so does the value of each token, providing capital gains to the token holders. In some cases, new tokens are minted and distributed to each owner accordingly, such as if there are multiple owners to a property management company or to multiple properties. Token holders can also deposit or lease their tokens to others, earning a passive income. This approach allows others to use the tokens temporarily, such as for rental income, while the original token holder continues to derive financial benefit.

In some cases, the asset owner divides the value of a single asset (say, a house) into several tokens. Each token represents a proportional stake in the returns from the asset (like rent). The tokenization system enables transfer of property ownership to a token holder who accumulates tokens equivalent to the asset's total value. In such a case, the tokens corresponding to that asset are removed from circulation or “purged.”

In some cases, the tokenization system enables an asset owner to have several assets (say, multiple properties). Here, the total value of all assets is divided into tokens, each representing a proportional stake in the returns from all assets. Alternatively, each individual asset can also have its own token representation. The tokenization system enables token holders to acquire ownership of an individual asset or a percentage of a group of assets by accumulating tokens equivalent to the asset's total value. In some cases, different owners of the same or different properties can each tokenize their equity and/or ownership.

This kind of tokenized asset ownership provides investors with a new way to diversify their portfolios and potentially lower barriers to entry in markets like real estate using the technological advances of tokenization.

Although examples described herein refer to asset or real estate property, it is appreciated that examples described herein can refer to other types of assets, including both physical and/or intangible assets. For example, assets can refer to vehicles, such as cars, boats, planes, and other vehicles, allowing investors to own a piece of these assets and potentially share in their appreciation over time.

In some cases, the assets refer to artwork and/or collectibles, such as paintings, sculptures, rare collectibles, and other valuable items that can be tokenized to enable broader ownership. This could lower the barriers to entry in the art investment market, which has traditionally been accessible only to the wealthy.

In some cases, assets refer to intellectual property, such as copyrights, patents, and other forms of intellectual property. This could enable creators to raise funds while allowing investors to share in the potential profits from these assets.

In some cases, assets refer to commodities such as gold, oil, or agricultural products, providing another way for investors to gain exposure to these markets. In some cases, assets refer to business equity, allowing investors to buy and sell tokens representing shares in the company. In some cases, assets refer to debt instruments, such as bonds or loans, which could create more flexibility and liquidity in the debt market. In some cases, assets refer to digital assets such as domain names, digital art (such as non-fungible tokens—NFTs), and in-game assets.

### Tokenization Protocol for Physical Commodity Ownership Transfer

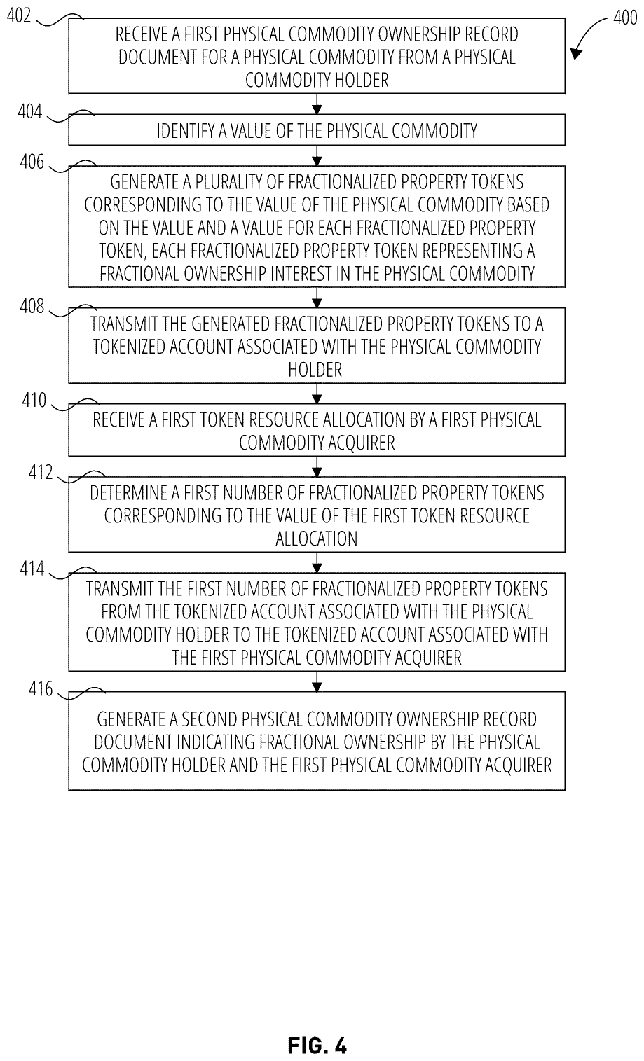

FIG. 4 illustrates an example method 400 for a tokenization protocol for physical commodity ownership transfer, according to some examples. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

At block 402, the tokenization system receives a first physical commodity ownership record document for a physical commodity from a physical commodity holder. The tokenization system acquires a digital representation of the legal rights associated with a physical commodity, provided by the individual or entity that currently holds those rights. The physical commodity can be any form of real-world property, such as real estate, vehicles, artwork, or other valuable goods.

In some cases, the physical commodity includes a real estate property, such as a home, a building, a car, equipment such as recording equipment, material such as gold or steel, technology such as a server or radio station, factories, production facilities, and/or the like. The physical commodity can include any real world object that can be divided based on its value, such as into tokens or fractionalized property tokens.

The physical commodity ownership record includes a legal document that establishes the ownership and rights associated with the physical commodity. This could be a deed for a property, a title for a vehicle, or any other legal document that establishes ownership.

The process of digitizing this title involves taking a picture or scanning a physical copy of the physical commodity ownership record. The tokenization system converts the information within the physical commodity ownership record into a digital format that can be stored, transmitted, and processed electronically. In some cases, the tokenization system scans the physical commodity ownership record and applies optical character recognition (OCR) to extract text.

The tokenization system can apply a machine learning model to map data fields in the physical commodity ownership record to relevant data fields in the tokenization system database. In some cases, the tokenization system standardizes data in the physical commodity ownership record. For example, formats and data can be different across different documents, such as abbreviations, acronyms, and/or formats (e.g., zipcodes). The tokenization system standardizes such data, such as using a machine learning model, in order to store and process the data.

With data in standardized format, the tokenization system can compare data to other data in its database. If the tokenization system desires to send data back to the computing system that transmitted the physical commodity ownership record or other third party databases, the tokenization system converts the data into the non-standardized format of the receiving party.

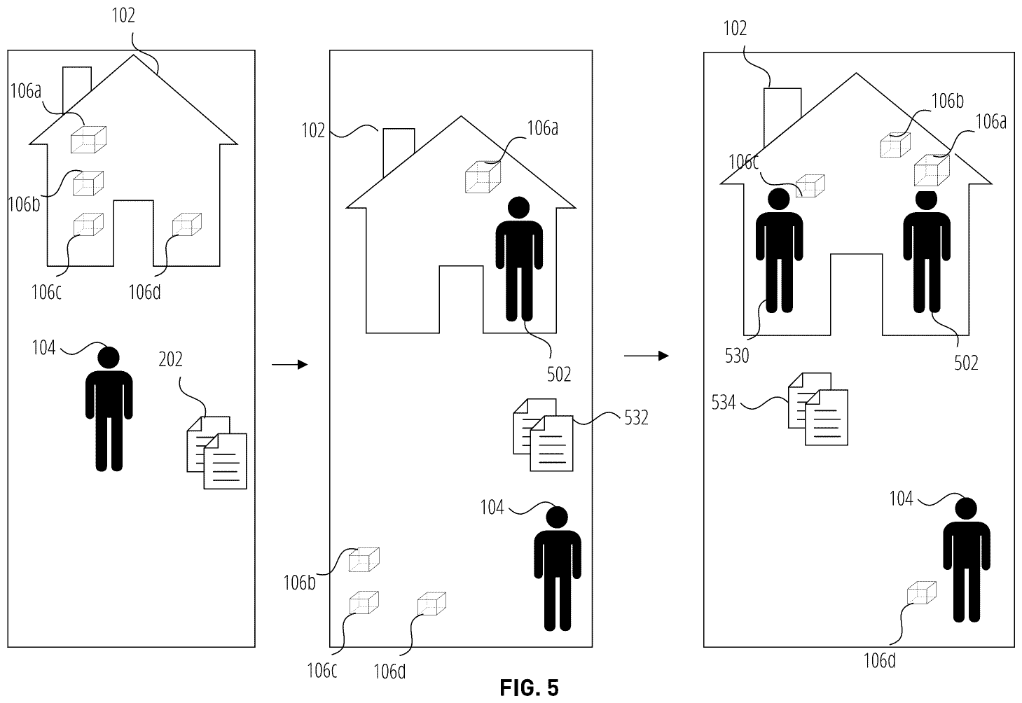

FIG. 5 illustrates an architectural diagram of tokenized asset ownership transfer, according to some examples. The physical commodity holder (such as the asset owner 104) provides a physical commodity ownership record (such as a deed 202) to the tokenization system.

At block 404, the tokenization system identifies a value of the physical commodity. The tokenization system determines a monetary worth of the physical commodity. The tokenization system determines the value of the physical commodity through one or a variety of ways. In some cases, the tokenization system determines the value of the physical commodity depending on the type of physical commodity. For instance, in the case of real estate, the value could be determined through a professional appraisal system, comparative market analysis, or valuation models.

In some cases, the tokenization system applies a valuation model, such as a machine learning model. The tokenization system inputs one or more characteristics of the property. The tokenization system identifies such characteristics based on information from the physical commodity ownership record and/or third party databases. For example, the tokenization system can retrieve an address from the physical commodity ownership record and retrieve characteristics of the property, such as the number of bedrooms, square footage, and/or the like from third party databases.

In some cases, the tokenization system trains and applies a machine learning model that can generate textual or visual descriptions of assets. In some cases, such a machine learning model is a transformer type machine learning model transforming text to an image of the asset, such as using text-to-image machine learning models. The textual or visual descriptions can be searched using queries. For example, a user can search “nice place in a gentrified neighborhood” or “apartment looks like the one in friends.” The machine learning model takes characteristics of the property from multiple different sources, such as google maps or a government database, and identifies features of the query, such as features in the latent space. The machine learning model identifies relevant assets that match the desired query. In some cases, a user can draw an asset and the machine learning model, through its generated textual or visual descriptions, identifies the closest matching asset for the user. For example, the user can draw a house with a flat top, four windows in the front, and a three bedroom apartment, and the machine learning model can identify homes that meet this criteria for the user.

In some cases, the tokenization system inputs characteristics of the physical commodity into the model, such as the condition, size, location, address, characteristics of the neighborhood, and other factors. The model is trained to identify similar properties (such as properties in a similar neighborhood that share certain characteristics of the physical commodity) and compares the property to these other similar properties that have recently sold in the same area to determine its estimated market value. In some cases, the machine learning model outputs such characteristics as described herein such as based on other characteristic inputs.

In some cases, the valuation models use mathematical modeling combined with databases of existing properties and transactions to calculate property values. These models can quickly provide an estimate of a property's value based on available data. This value serves as the basis for generating the fractionalized property tokens that represent ownership of the physical commodity. This value is also used by the tokenization system, machine learning models, and/or smart contracts in accepting transactions if the value is within an acceptable range of values.

At block 406, the tokenization system generates a plurality of fractionalized property tokens corresponding to the value of the physical commodity. For example, the tokenization system generates fractionalized property tokens based on the market value and a value for each fractionalized property token. Each fractionalized property token represents a fractional ownership interest in the physical commodity.

The tokenization system creates (or mints) fractionalized property tokens that represent fractional ownership in the physical commodity. These fractionalized property tokens are generated in a quantity that corresponds to the previously determined value of the physical commodity.

The tokenization system identifies a value for each fractionalized property token. The tokenization system can set the price of each fractionalized property token. The price can be set by a user such as the physical commodity holder, and/or the price can be set by the market (such as based on buy and sell orders on an exchange that exchanges fractionalized property tokens for other monetary value such as money). The fractionalized property token price can be a standard value across all physical properties, and/or it could vary based on factors such as the type of physical commodity, the total value of the physical commodity, or market conditions.

Once the value per fractionalized property token is identified, the system determines the number of fractionalized property tokens to be generated that corresponds to the value of the physical commodity. For example, the tokenization system divides the total value of the physical commodity by the value of each fractionalized property token. For example, if a property is worth $100,000 and each fractionalized property token is worth $100, the system would generate 1,000 fractionalized property tokens. In another example, four fractionalized property tokens, such as fractionalized property tokens 106a, 106b, 106c, and 106d, are considered equal in value to the home, and the fractionalized property tokens 106 of FIG. 5 are generated by the tokenization system.

Each of these fractionalized property tokens represents a fractional ownership interest in the physical commodity. For instance, in the above example, each fractionalized property token would represent a 0.1% ownership interest in the property.

The tokenization system can initiate a distributed ledger and/or blockchain technology to generate the fractionalized property tokens. The tokenization system initiates the blockchain to create unique, non-fungible fractionalized property tokens that can be securely tracked and transferred. Each fractionalized property token is a digital asset that is stored on the blockchain, providing a transparent and immutable record of ownership.

Once generated, these fractionalized property tokens can be bought, sold, leased, or traded, allowing for the fractionalization of ownership in the physical commodity. This enables individuals to invest in expensive physical properties such as real estate without needing to purchase the entire physical commodity outright or having to make a large down payment and sign onto a mortgage. The tokenization system also provides a mechanism for transferring ownership of the physical commodity over time, as individuals can gradually acquire fractionalized property tokens until they own a majority or the entirety of the fractionalized property tokens associated with the physical commodity.

In some cases, the asset owner places restrictions on the tenant, and/or vice versa. For example, the asset owner can place restrictions on purchasing, selling or leasing tokens by a tenant. In another example, only an individual under a usage contract can purchase tokens and they cannot sell them while under contract.

At block 408, the tokenization system transmits the generated fractionalized property tokens to a tokenized account associated with the physical commodity holder. A tokenized account includes a software-based system that securely stores users' digital assets, such as cryptocurrencies and/or asset-backed fractionalized property tokens.

The tokenization system initiates the transmission process once the fractionalized property tokens have been generated. The tokenization system initiates a transaction on the blockchain network to move the tokens from the system's wallet (or a temporary holding wallet) to the physical commodity holder's wallet.

The tokenization system initiates the creation of a digital signature using its private key, which is then broadcasted to the blockchain network. The network's nodes validate the transaction, ensuring that the tokenization system has the necessary balance of fractionalized property tokens to perform the transaction and that the digital signature matches the system's public key.

Once validated, the transaction is added to a block of transactions, which is then added to the blockchain. This process ensures the immutability and transparency of the transaction, providing a clear record of the transfer of fractionalized property tokens from the system to the physical commodity holder.

The physical commodity holder's tokenized account will then update to reflect the receipt of the new fractionalized property tokens. The physical commodity holder then manages these fractionalized property tokens within their wallet, including transferring them to other wallets or using them in transactions.

For example, as shown in FIG. 5, the physical commodity (such as a home 102) has value equivalent to 4 fractionalized property tokens 106a, 106b, 106c, and 106d. The tokenized account of the physical commodity holder (such as the asset owner 104) initially receives all 4 tokens.

At block 410, the tokenization system receives a first token resource allocation by a first physical commodity acquirer. In some cases, the tokenization system periodically receives signals or notifications of token resource allocations from the physical commodity acquirer during a specified period of physical commodity use. The physical commodity acquirer could be a tenant, a renter, or any other party who is using the physical commodity but does not fully own it. In some cases, the tokenization system receives token resource allocations by a physical commodity acquirer that is not currently using or occupying the physical commodity.

The tokenization system can receive token resource allocations that can relate to one or more different actions related to the use or partial acquisition of the physical commodity. For instance, the tokenization system receives an indication of a rent payment, a purchase of fractionalized property tokens representing ownership in the physical commodity, or the like. In some cases, the tokenization system determines such payment is made from a third party financial database or server. In other cases, the payment is made directly to the tokenization system.

In some cases, the tokenization system receives token resource allocations for insurance payments, tax refunds, and/or other forms of payment. For example, if insurance payments were also made by the tenant, a smart contract initiates payment back to the home owner and tenant according to their proportional ownership.

The tokenization system receives the indication of the token resource allocation via digital signal or message sent from the physical commodity acquirer's tokenized account or account to the system. The indication includes information about the transaction, such as the amount paid, the number of fractionalized property tokens purchased, and the time of the transaction.

The tokenization system receives this indication and processes it to update the records of the physical commodity and the associated fractionalized property tokens. The tokenization system updates the balance of fractionalized property tokens in the physical commodity acquirer's tokenized account, updating the remaining value of the physical commodity, and/or updating the record of payments made by the physical commodity acquirer.

At block 412, the tokenization system determines a first number of fractionalized property tokens corresponding to the value of the first token resource allocation. In some cases, the first token resource allocation includes a payment made by the physical commodity acquirer. The tokenization system determines a number of property tokens equal to the value of the payment made.

In some cases, the first tokenization resource allocation includes a number of tokens transmitted by the physical commodity acquirer. The tokenization system can identify that such a tokenized resource allocation was made by the physical commodity acquirer for the home 102. The tokenization system can identify such allocation by identifying the transfer of tokens to the physical commodity holder's wallet and/or to another wallet, such as a wallet of the tokenization system.

At block 414, the tokenization system transmits the first number of fractionalized property tokens from the tokenized account associated with the physical commodity holder to the tokenized account associated with the first physical commodity acquirer.

The tokenization system facilitates the transfer of a specific number of fractionalized property tokens from the tokenized account of the physical commodity holder to the tokenized account of the physical commodity acquirer, such as fractionalized property token 106a to the acquirer 502.

In some cases, the transfer process begins with the tokenization system initiating a transaction on the blockchain network. This transaction involves moving the specified number of fractionalized property tokens from the physical commodity holder's wallet to the physical commodity acquirer's wallet.

The tokenization system creates a digital signature for the transaction using the private key associated with the physical commodity holder's wallet. This signature is then broadcasted to the blockchain network, where it is validated by the network's nodes. The nodes check that the physical commodity holder's wallet has a sufficient balance of fractionalized property tokens and that the digital signature matches the public key associated with the wallet.

Once validated, the transaction is added to a block of transactions, which is then added to the blockchain. This process ensures the immutability and transparency of the transaction, providing a clear record of the transfer of fractionalized property tokens from the physical commodity holder to the physical commodity acquirer.

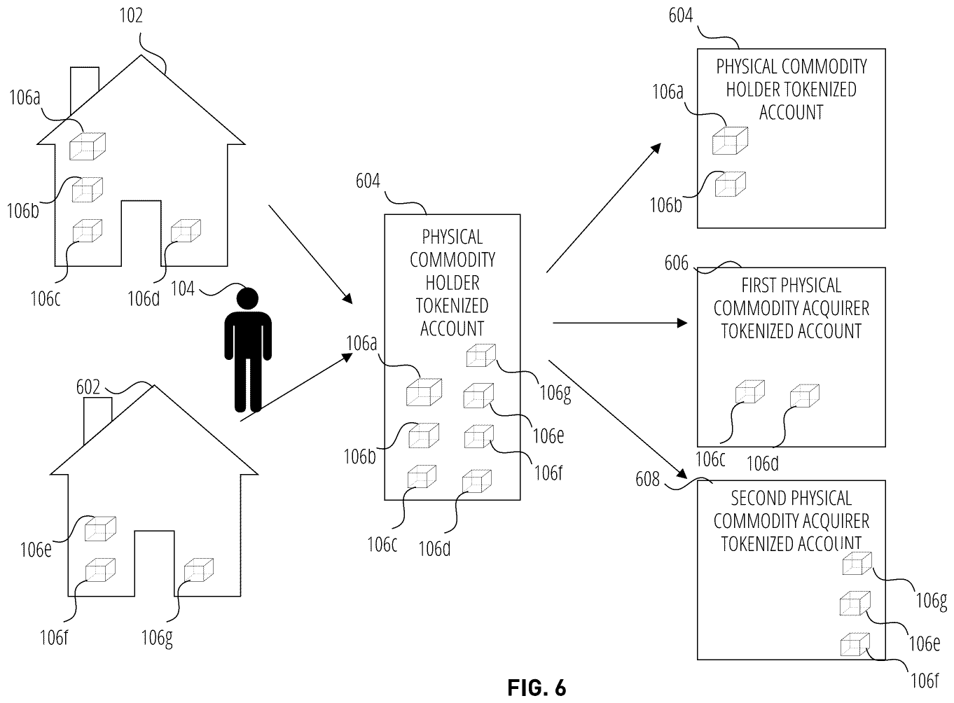

Over time, the physical commodity acquirer 502 acquires tokens representing fractional ownership of the physical commodity. For example, in FIG. 6, the physical commodity acquirer acquires one fractionalized property token 106a, and is now a ¼ owner of the home.

At block 416, the tokenization system generates a second physical commodity ownership record document indicating fractional ownership by the physical commodity holder and the first physical commodity acquirer.

In some cases, generating the second physical commodity ownership record document indicating fractional ownership by the physical commodity holder and the first physical commodity acquirer is in response to determining a remaining number of fractionalized property tokens in the tokenized account associated with the physical commodity holder. As such, if tokens remain in the tokenization account of the physical commodity holder, the physical commodity holder is still a fractional owner of the physical commodity. Thus, the second physical commodity ownership record document, such as second physical commodity ownership record document 532, includes ownership by both the physical commodity holder and the first physical commodity acquirer.

As shown in FIG. 5, as the first physical commodity acquirer increases ownership of the property (e.g., now owns tokens 106a, 106b), and another physical commodity acquirer 530 submits a token resource allocation and the tokenization system transfers a token (e.g., token 106c) to the tokenized account for the second commodity acquirer. The physical commodity holder still maintains ¼ ownership by holding the token 106d in the physical commodity holder's tokenized account. The first physical commodity acquirer now has ½ ownership, and the second physical commodity acquirer has ¼ ownership.

The tokenization system generates a third physical commodity ownership record document 534 indicating fractional ownership by the physical commodity holder, the first physical commodity acquirer, and the second physical commodity acquirer.

In some cases, the first physical commodity includes a real estate property, the first physical commodity ownership record including a digitized deed, and the first physical commodity holder including a real estate property owner, and the physical commodity acquirer including a real estate property purchaser.

### Collection of Physical Commodities

Some examples described herein are described according to one real world property. However, it is appreciated that the examples and features can apply to a collection of assets, such as a portfolio of properties owned by a developer or a real estate company. In this case, the “physical commodity” referred to herein include multiple individual assets, each of which could be a separate property.

FIG. 6 illustrates ownership transfer for a collection of physical commodities, according to some examples. For example, the assets can be equivalent to a certain set amount of tokens. In other examples, the assets acquire tokens based on the value of the individual asset (e.g., the tokens are set to a particular price, and the tokens given to an individual asset are based on the number of tokens equivalent to the asset value).

The physical commodity holder provides digitized asset rights documents for each property in the collection. The system identifies the total value of the collection of properties, such as for home 102 and home 602. The system generates fractionalized property tokens corresponding to the total value of the collection of assets, such as tokens 106a, 106b, 106c, 106d, 106c, 106f, and 106g. Each token represents a fractional ownership interest in the entire collection, not just a single property. Thus, a physical commodity acquirer who purchases tokens is gaining equity in the entire collection of properties, not just one property.

The tokens can be transferred to a physical commodity holder tokenized account 604. In some cases, the tokens are transferred to two separate accounts, such as a first physical commodity holder tokenized account for the first home 102, and a second physical commodity holder tokenized account for the second home 602.

A first physical commodity acquirer purchases tokens 106c and 106d, and the second physical commodity acquirer purchases tokens 106g, 106e, and 106f. The tokenization system transfers tokens 106c and 106d to the first physical commodity acquirer's tokenized account 606 and tokens 106g, 106e, and 106f to the second physical commodity acquirer's tokenized account 608. The physical commodity holder maintains partial ownership by holding tokens 106a and 106b in the tokenized account 604.

This approach allows a developer or real estate company to tokenize a portfolio of properties and sell fractional ownership interests to multiple physical commodity acquirers. It provides a flexible and efficient way for physical commodity acquirers to gain equity in a collection of properties, and it allows the physical commodity holder to raise capital by selling tokens.

### Collaborative Tokenization of Physical Commodities

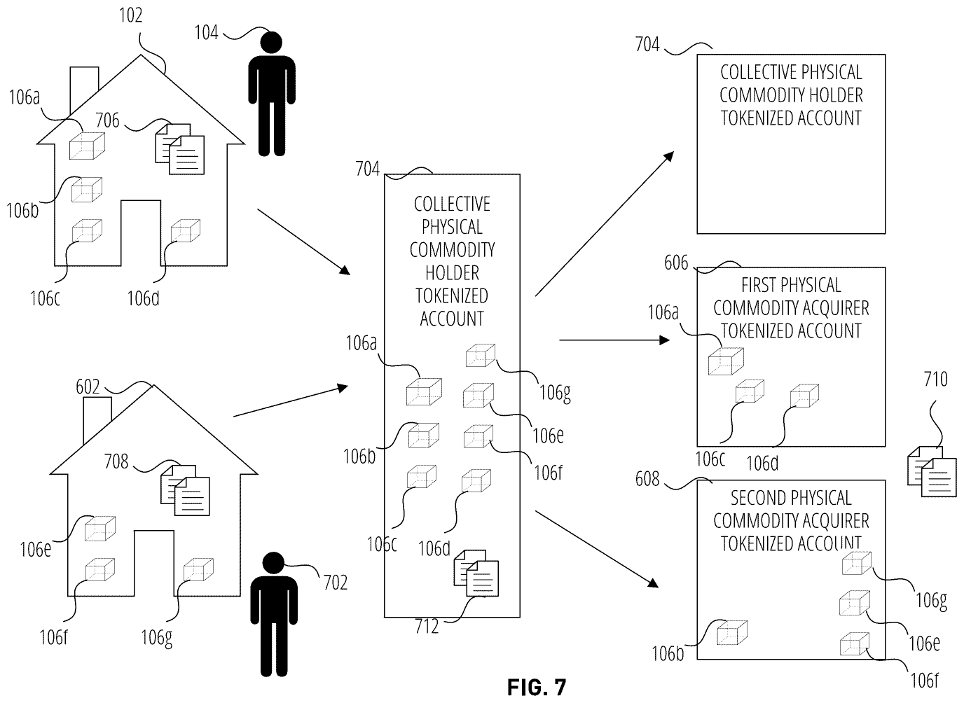

FIG. 7 illustrates collaborative tokenization of physical commodities for ownership transfer, according to some examples. The tokenization system can communicate with multiple physical commodity holders to collectively tokenize multiple physical commodities under a single tokenization schema.

A first physical commodity holder (such as the asset owner 104) owns a first home 102, and a second physical commodity holder 702 owns a second home 602. The first physical commodity holder submits a first physical commodity ownership record document 706 and the second physical commodity holder submits a second physical commodity ownership record document 708 to the tokenization system.

The tokenization system assesses the value of each physical commodity. For example, the tokenization system determines that the first home is equivalent to 4 tokens, and transfers 4 tokens, such as tokens 106a, 106b, 106c, and 106d, to the first physical commodity holder's tokenized account. The tokenization system determines that the second home is equivalent to 3 tokens, and transfers 3 tokens, such as tokens 106c, 106f, and 106g, to the second physical commodity holder's tokenized account.

In some cases, the tokens are transferred to a collective physical commodity holder tokenized account. For example, the tokenization system transfers all 7 tokens, 106a, 106b, 106c, 106d, 106c, 106f, and 106g to the collective physical commodity holder tokenized account 704.

The tokenization system generates a third physical commodity ownership record document 712 indicating fractional ownership by the first and second physical commodity holder. In some cases, the tokenization system records the collective ownership on a database, such as a third party government agency database, as further described herein.

In some cases, one or more physical commodity acquirers can obtain tokens to gain fractional and/or full ownership of the collection of physical commodities. The first physical commodity acquirer acquires 3 tokens, such as tokens 106a, 106c, and 106d, and a second physical commodity acquirer acquires 4 tokens, such as tokens 106b, 106g, 106c, and 106f. The tokenization system transmits the 3 tokens to the first physical commodity acquirer's tokenized wallet, and 4 tokens to the second physical commodity acquirer's tokenized wallet.

In some cases, the tokenization system determines that a quantity of fractionalized property tokens within a single tokenized account of the physical commodity acquirer meets or exceeds the number of fractionalized property tokens corresponding to the value of the physical commodity. The tokenization system checks the balance of fractionalized property tokens in the physical commodity acquirer's tokenized account and compares the amount to the total number of fractionalized property tokens that correspond to the full value of the physical commodity.

In some cases, the tokenization system determines that a quantity of fractionalized property tokens across multiple tokenized accounts of physical commodity acquirers meet or exceed the number of fractionalized property tokens corresponding to the value of the physical commodity. In such cases, the tokenization system determines that a single physical commodity acquirer and/or multiple physical commodity acquirers have acquired all tokens from the physical commodity holder, and thus the physical commodity holders are no longer the owners of the physical commodity.

The tokenization system retrieves the current balance of fractionalized property tokens in the physical commodity acquirer's tokenized account. In the case where a distributed ledger is used, the tokenization system queries the blockchain network for the wallet's address and retrieving the associated balance. The tokenization system compares this balance to the total number of fractionalized property tokens that were initially generated to represent the full value of the physical commodity.

In some cases, the tokenization system reassesses a total number of fractionalized property tokens based on the current price of the physical commodity. For example, the physical commodity appreciates (or depreciates) naturally over time. In some cases, modifications or damage occurs to the physical commodity over time, and thus the value appreciates or depreciates.

If the balance of fractionalized property tokens in the physical commodity acquirer's wallet equals or exceeds the total number of fractionalized property tokens, the tokenization system determines that the physical commodity acquirer has acquired full ownership of the physical commodity. This could be the result of the physical commodity acquirer gradually purchasing tokens over time, or of one or more large transactions in which the physical commodity acquirer purchases some or all of the required fractionalized property tokens.

In some cases, the full ownership occurs automatically when the balance of tokens in the physical commodity acquirer's wallet equals or exceeds the total number of tokens. In some cases, the physical commodity acquirer is provided the option to acquire the asset upon reaching the required number of tokens.

In some cases, the tokenization system transfers and/or records the physical commodity ownership record for the physical commodity to the physical commodity acquirer. The transferring indicates full ownership of the physical commodity by the physical commodity acquirer.

This transfer is triggered when the tokenization system determines that the quantity of fractionalized property tokens in the physical commodity acquirer's tokenized account equals or exceeds the total number of fractionalized property tokens corresponding to the full value of the physical commodity, indicating that the physical commodity acquirer has acquired full ownership.

The physical commodity ownership record includes a digital version of a deed, title, or other legal document, such as document 710, that establishes ownership of the physical commodity. This document is stored in a secure, tamper-proof format of the tokenization system, such as a blockchain or a secure database.

The tokenization system initiates the transfer of the physical commodity ownership record by creating a transaction on the blockchain or updating the database to reflect the change in ownership. The tokenization system can change the owner field in the physical commodity ownership record to the identifier of the physical commodity acquirer, or creating a new physical commodity ownership record with the physical commodity acquirer as the owner and invalidating the previous document.

The tokenization system initiates broadcasting of the transaction or update to the network or commits the change to the database, where it is validated and recorded. This process ensures the immutability and transparency of the ownership transfer, providing a clear and indisputable record of the physical commodity acquirer's ownership.

Once the transfer is complete, the physical commodity acquirer has full legal ownership of the physical commodity, as represented by the physical commodity ownership record. The physical commodity acquirer becomes the new physical commodity holder and can exercise all rights and privileges associated with ownership, such as selling the physical commodity, using it as collateral, or making modifications to the physical commodity. Moreover, the physical commodity acquirer, now as the new physical commodity holder, can offer a similar schema of tokenizing the property and enabling a new tenant to rent and purchase equity progressively, as further described herein.

Although examples describe features, such as features related to deeds and/or documents, for a single acquirer or commodity holder, it is appreciated that such features apply to a scenario with multiple acquirers and/or commodity holders, and vice versa.

In some cases, the tokenization system receives a second token resource allocation, determines a second number of fractionalized property tokens corresponding to the value of the second token resource allocation, transmits the second number of fractionalized property tokens from the tokenized account associated with the physical commodity holder to another tokenized account, determines that tokenized account associated with the physical commodity holder does not include fractionalized property tokens for the physical commodity, and generates a third physical commodity ownership record document removing ownership by the physical commodity holder.

In some cases, one or more steps of the tokenization system is performed by a machine learning model. For example, the tokenization system applies the first physical commodity ownership record to a machine learning model. The machine learning model is trained to perform the operations of identifying the value of the physical commodity, generating the plurality of fractionalized property tokens corresponding to the value of the physical commodity based on the value and the value for each fractionalized property token, and transmitting the generated fractionalized property tokens to the tokenized account associated with the physical commodity holder.

In some cases, the tokenization system applies the first token resource allocation to a machine learning model. The machine learning model is trained to perform the operations of determining a first number of fractionalized property tokens corresponding to the value of the first token resource allocation, transmitting the first number of fractionalized property tokens from the tokenized account associated with the physical commodity holder to the tokenized account associated with the first physical commodity acquirer, and generating a second physical commodity ownership record document indicating fractional ownership by the physical commodity holder and the first physical commodity acquirer.

The system ensures proper ownership exchange by maintaining a clear and immutable record of all transactions related to the asset, including the initial tokenization of the asset and all subsequent transfers of tokens. This record serves as a digital chain of title, providing a transparent history of the asset's ownership.

When the physical commodity holder first submits the digitized asset rights document (such as a deed) to the system, the system records this transaction on the blockchain or in a secure database. This initial record includes the physical commodity holder's identity, the value of the asset, and the number of tokens generated.

Each time tokens are transferred from one tokenized account to another, the system records the transaction. This includes transfers from the physical commodity holder to the physical commodity acquirer, as well as any subsequent transfers between different physical commodity acquirers. Each record includes the identities of the sender and receiver, the number of tokens transferred, and the time of the transfer.

When the quantity of tokens in the physical commodity acquirer's tokenized account equals or exceeds the total number of tokens corresponding to the value of the asset, the system recognizes this as a transfer of ownership. In other cases, the system provides the option of transfer of ownership. The system updates the digitized asset rights document and/or generates a new document to reflect the physical commodity acquirer as the new owner and records this transaction.

The system maintains a complete record of all these transactions, creating a digital chain of title for the asset. This chain of title provides a clear and indisputable history of the gradual change in asset's ownership as well as the final transfer of full ownership.

By maintaining this digital chain of title, the system ensures that the ownership transfer is transparent, secure, and legally valid. The blockchain technology used in this process provides additional security by making the record immutable, meaning it cannot be altered or deleted once it's been recorded. This prevents fraud and disputes over ownership, providing peace of mind for all parties involved.

In some cases, the tokenization system generates legal documents to formalize each transfer of ownership. For example, when the physical commodity acquirer acquires enough tokens to become the owner, the system could generate a new deed or title in the physical commodity acquirer's name for the physical commodity acquirer and the physical commodity holder to sign. This document would be legally binding and could be recorded with the appropriate government agency.

In some cases, the tokenization system applies a machine learning model that is trained to generate required documents for a particular property. For example, the machine learning model generates different documents for an apartment complex, a single family home, a commercial property, or for an automobile. In some cases, the machine learning model generates documents required for different jurisdictions, such as based on state law or documents needed for foreign jurisdictions.

In some cases, upon the physical commodity acquirer acquiring enough tokens, the system uses a third-party escrow system to hold the digitized asset rights document and oversees the transfer of ownership. The escrow system ensures that the physical commodity acquirer has enough tokens before transferring the document to them.

In some cases, the tokenization system uses digital signatures to authenticate each transaction. Both the sender and receiver of tokens signs each transaction (such as with their private keys), providing a secure and verifiable record of the transaction.

In some cases, the system integrates online notary systems to notarize the transfer of ownership. This would provide an additional layer of legal assurance that the transfer is valid.

In some cases, the system automatically records, such as at a government agency database, a change of ownership. For example, the government agency database can hold a chain of title for a real estate property. The tokenization system initiates transmission of a message to the government agency database for the recordation of the new ownership to add to the chain of title.

In some cases, the system creates a new token recordation system that replaces and/or augments a centralized database, such as a government agency database. This can be useful if government agency databases are not complete and/or if no database currently exists.

In some cases, the tokenization system applies a machine learning model to optimize various aspects of the tokenization system. In some cases, the tokenization system applies historical data to the machine learning model, such as historical physical commodity ownership records, historical contracts between the owner and user of the physical commodity, and/or the like and trains the model to generate an optimal token resource allocation, such as an amount or value of the asset, and/or usage duration of the asset. The tokenization system uses the amount or value of the asset to verify a transaction as being within an acceptable range of the valuation.

The tokenization system trains a machine learning model using previous real estate contracts associated with different properties. Based on various factors such as property value, location, market conditions, historical trends, and more, the machine learning model is trained to estimate an optimal transaction amount and/or contract duration for a new property that's being tokenized.

For example, if the property is similar to previous assets, the machine learning model is trained from historical data to suggest terms based on an assessment of what happened for the previous assets. The machine learning model is trained to determine how quickly tokens were purchased for past property, any trends in token purchases, and so forth, to suggest a contract duration. Similarly, the machine learning model is trained to look at token prices in relation to the property value to suggest an optimal token price.

In some cases, the machine learning model is trained to perform one or more features of the tokenization system on assets that are non-similar. The machine learning model receives as input various characteristics of multiple properties, generate hidden latent variables across the different properties that factor into valuation, and applies such latent variables to compare properties that are dissimilar.

The tokenization system applies such models for the benefit of various entities. The tokenization system can help the physical commodity holder in determining the parameters for their token offering. The tokenization system can help the tenant in evaluating different tokenization offers and finding the one that matches their financial capacity and goals. The tokenization system also applies such models to smart contracts to verify transaction by ensuring the values are within the range of values that the machine learning model estimates or outputs.

In some cases, the tokenization system trains a machine learning model by applying input lease agreements associated with different assets to determine the forecast expected total cost to a tenant or acquirer for ownership and provide a comparison for different options.

The tokenization system trains a machine learning model to analyze past contracts and/or current market conditions to forecast a value a tenant or acquirer could expect to submit over time to gain ownership of a property using the fractionalized property tokens. The machine learning model is also trained to compare this total value against other options, such as compared to traditional home buying or other tokenized processes.

The tokenization system trains a machine learning model to use various inputs such as the property's token price, the length of the contract, market trends, and other relevant data. The model can process this information to generate a projection of total value to be submitted and uses this forecast to compare different home ownership options. The tokenization system helps tenants or acquirers make informed decisions about the most cost-effective way to gain homeownership.

In some cases, the tokenization system trains a machine learning model to review a smart contract and translate the contract into a form aligned with certain specified criteria. Smart contracts include self-executing contracts with the terms of the agreement directly written into code. The smart contracts detail the terms of the tokenization agreement, including token price, number of tokens, contract duration, and/or the like.

The machine learning model receives the smart contract code as input and translate the code into a format that aligns with the acquirer's specific criteria or requirements, such as reinterpreting the terms into a more readable format, highlighting key terms and conditions, or mapping terms to specific criteria set by the acquirer.

As such, the tokenization system applies such a machine learning model to help acquirers to quickly understand the terms of various tokenization contracts, and how they align with their specific needs and goals. It would make the process of comparing and choosing between different tokenization options more accessible and user-friendly.

In some cases, the tokenization system applies a machine learning model that receives as input previous asset valuations and a new asset valuation report. The machine learning model is trained to determine a valid value range for the new asset. The tokenization system applies the value range as a parameter for confirming transaction validity by the distributed network of nodes. In some cases, the tokenization system enables the physical commodity holder to apply such data to better calibrate asset tokenization parameters. In some cases, the tokenization system enables a potential token owner to apply such data to evaluate different token purchase options.

In some cases, the tokenization system leaves the tokens in the physical commodity acquirer tokenized account. In other cases, the tokenization system purges the tokens from circulation. If the tokenization system keeps the tokens in the physical commodity acquirer tokenized account, the physical commodity acquirer can use them to rent the asset to another acquirer, effectively becoming the new physical commodity holder.

If the tokens are purged, the tokenization system removes the tokens from the physical commodity acquirer's tokenized account and updates the blockchain or database to reflect the reduced supply of tokens. Advantageously, purging of the coins prevents the physical commodity acquirer from selling the property using the tokens and/or selling the property separately using the asset ownership document.

In some cases, the tokenization system purges tokens after all tokens have been transferred out of the physical commodity holder tokenized account, such that the tokens are now fully transmitted to physical commodity acquirer's tokenized accounts. The tokenization system generates the physical commodity ownership record document recording the ownership change from the physical commodity holder to the physical commodity acquirer, and purges the tokens from circulation.

### Use Rights

In some cases, the tokenization system automatically enables access to the asset, such as based on a threshold of ownership. In some cases, the tokenization system enables full and/or partial access based on ownership meeting a certain threshold. If the acquirer gains 25% ownership via tokens, the tokenization system can enable the acquirer access to certain units, rooms, common areas, and/or the like. In some cases, the tokenization system enables all or a subset of features, such as access to electrical systems and/or turning on or off certain systems.

The tokenization system automatically configures digital locks or security systems. In some cases, the tokenization system generates a unique access code for the physical commodity acquirer upon receipt of the exchange. The tokenization system sends the physical commodity acquirer this code, allowing them to access the property.

In some cases, tokens owned by the asset user are held by the asset owner while the asset is being used. The tokenization system can revoke access to the asset by the user, such as when the user is withdrawing the tokens from the owner's digital token storage. In some cases, the tokenization system places the tokens in a “system held” state where the tokens cannot be sold/loaned by the token owner nor have access to the asset. The tokenization system can apply such a hold for example in a force majeure situation (civil unrest, hurricane, etc.) where saving the asset is a priority.

In some cases, the tokenization system uses smart contracts on the blockchain to automatically grant access rights to the physical commodity acquirer. The smart contract is programmed to change the status of the asset to ‘in use’ by the physical commodity acquirer upon receipt of the exchange. Such a status initiates (and/or the smart contract initiates configuration of) proper technology, as described herein, to enable access to the property.

In some cases, the tokenization system configures Internet of Things (IoT) devices that are connected to the asset. The tokenization system sends commands to these devices to grant access to the physical commodity acquirer. For example, the tokenization system sends a command to unlock the doors of a rental property or to activate utilities of a car.

For assets such as rental properties or shared spaces, the tokenization system integrates with existing reservation platforms. Upon receipt of the use exchange, the tokenization system automatically books the property for the physical commodity acquirer for the agreed-upon period.

In some cases, the tokenization system generates legal documents, such as lease agreements, that grant the physical commodity acquirer the right to use the property. In some cases, the tokenization system generates such documents by identifying relevant data fields and populating the fields with information retrieved. The tokenization system applies the standardized data (as described further herein) to the forms to generate legal documents for the parties to sign.

In some cases, the tokenization system applies a machine learning model to generate such legal documents. The machine learning model is trained to receive information related to the asset, the physical commodity holder, and/or the physical commodity acquirer, and generate legal documents, based on training on historical asset, physical commodity holder, and physical commodity acquirer data.

In addition to the exchange, the physical commodity acquirer can also choose to purchase tokens that represent equity in the asset in an ownership exchange. This could be done at the same time as the exchange, or it could be done separately. Such ownership exchange can occur as a separate transaction or in the same transaction as the exchange. The number of tokens that the acquirer purchases is determined by the amount of monetary value the acquirer applies divided by the token value. For example, if each token is worth $100 and the acquirer chooses to put $100 towards equity, one token is transferred from the physical commodity holder tokenized account to the physical commodity acquirer tokenized account.

The system processes the exchange and the token purchase by updating the blockchain or the database to reflect the new token ownership. This could involve the blockchain debiting the acquirer's account for the amount of the exchange and the token purchase, crediting the physical commodity holder's account for the property occupancy, debiting the physical commodity holder's tokenized account of one token, and crediting the physical commodity acquirer's tokenized account of the one token.

The tokenization system provides different levels of access to acquirers with different amounts of tokens. For example, the tokenization system provides priority access offered to acquirers with a larger quantity of ownership tokens.

If the property has shared amenities such as a gym, swimming pool, community space, or services such as premium parking spaces, acquirers with more tokens could receive priority access to these amenities. In some cases, such priority access extends to property maintenance or repair services, where token-rich acquirers receive quicker responses or priority scheduling.

If an acquirer makes an improvement, such as a significant improvement, to the property (e.g., renovating a bathroom, installing solar panels), the tokenization system determines an increased value of the property (such as by applying features of property valuation as described herein) and mint additional tokens to distribute to the acquirer. This provides a tangible, direct benefit to the acquirer for their contributions to the property's value and again incentivizes property improvements.

The tokenization system enables acquirers with an electronic option to submit voting for decisions on the property. The tokenization system enables the acquirer to vote commensurate with their number of ownership tokens. This includes a vote in major property-related decisions, such as significant renovations, changes in property rules, or the selection of property management companies. Such a tokenization system democratizes the rental experience, allowing acquirers to have a say in decisions that would directly impact their lives, proportionate to their investment in the property. This includes decisions about community events, shared amenities, or even local governance issues.

In some cases, the asset owner can relinquish one or more rights to the token owners such as allowing other individuals to use (e.g., rent) the asset, scheduling of usage (timeshare), and/or the like. These rights can be based on a voting system of token owners (e.g. vote for usage commensurate on token ownership) or voting rights are given to each token owner proportional to token ownership (e.g. entitled to usage based on percentage ownership such as allocating seats on a plane). For example, a major change to the property can be voted on where if a first user has 25% ownership and a second user has 75% ownership, the second user has the majority vote already and thus can decide on the major change.

If a property were to be sold, the tokenization system enables token holding acquirers the right of first refusal, allowing them to initiate purchase of the property outright. This preemptive purchase right not only provides acquirers with a potential path to full property ownership, but also offers a measure of stability and predictability, as acquirers would have the first opportunity to secure their housing situation in the event of a sale.

The tokenization system displays user interfaces that enable acquirers to sell their tokens directly back to the property owner or on an open market. This flexibility provides a potential exit strategy for acquirers who need to liquidate their investment quickly, offering a degree of financial security and flexibility not found in traditionally rental systems.

The tokenization system provides a user interface and/or automatic token resource allocation that enables acquirers to pay for maintenance or renovation costs (such as by using a portion of the token resource allocation and/or tokens held in the token repository).

In some tokenization systems, the number of tokens an acquirer owns impacts their utility costs. For example, a percentage of the tokens owned could be applied as a credit towards utility bills, effectively reducing the cost of living in the property. In some cases, as the acquirer accrues more tokens, the tokenization system initiates discounts received on property-related services such as cleaning, maintenance, or utilities.

The tokenization system provides regular and successful payments of rent and token purchases to a credit bureau. These token transactions are reported to credit bureaus that reflect favorably on a person's credit report. Over time, this consistent token purchase record improves an acquirer's credit scores.

In some cases, a single property holder can divide the property into two different token types. Tokens can be of a different type based on one of several factors, such as price, tokenomics, distributed ledger, and/or the like. In some cases, a single person can own multiple properties and decide to group one subset of properties under one type of token and another subset under a second type of token. Such division can be based on certain factors, such as price of property, location of property, type of property (e.g., 1BR vs 2BR), and/or the like.

In some cases, the machine learning model recommends different exchange options such as based on the acquirer's token holdings, specified requirements for the property, property holder, and/or the acquirer, asset evaluations, and/or the like. The machine learning model can forecast changes in token and asset valuations. The tokenization system applies this information when executing a project (e.g. construction) where different assets (e.g. machinery) are required at different stages or when a property acquirer has multiple asset holdings.

### Machine Architecture

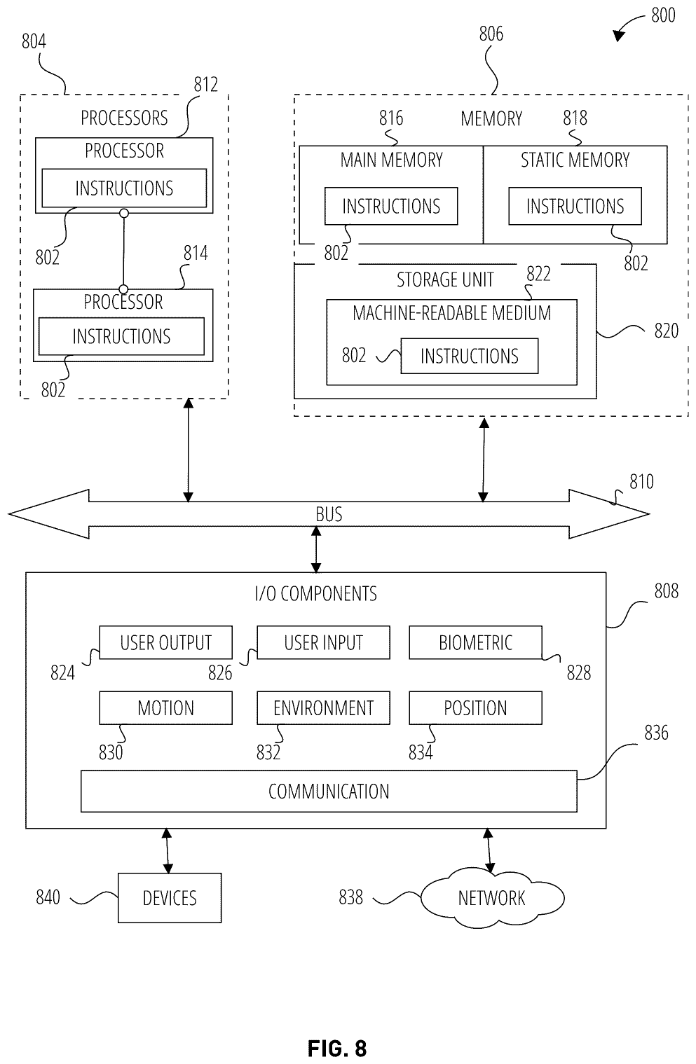

FIG. 8 is a diagrammatic representation of the machine 800 within which instructions 802 (e.g., software, a program, an application, an applet, an app, or other executable code) for causing the machine 800 to perform any one or more of the methodologies discussed herein may be executed. For example, the instructions 802 may cause the machine 800 to execute any one or more of the methods described herein. The instructions 802 transform the general, non-programmed machine 800 into a particular machine 800 programmed to carry out the described and illustrated functions in the manner described. The machine 800 may operate as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 802, sequentially or otherwise, that specify actions to be taken by the machine 800. Further, while a single machine 800 is illustrated, the term “machine” shall also be taken to include a collection of machines that individually or jointly execute the instructions 802 to perform any one or more of the methodologies discussed herein. The machine 800, for example, may comprise a user system or any one of multiple server devices forming part of the server system. In some examples, the machine 800 may also comprise both client and server systems, with certain operations of a particular method or algorithm being performed on the server-side and with certain operations of the particular method or algorithm being performed on the client-side.

The machine 800 may include processors 804, memory 806, and input/output (I/O) components 808, which may be configured to communicate with each other via a bus 810. In an example, the processors 804 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 812 and a processor 814 that execute the instructions 802. The term “processor” is intended to include multi-core processors that may comprise two or more independent processors (sometimes referred to as “cores”) that may execute instructions contemporaneously. Although FIG. 8 shows multiple processors 804, the machine 800 may include a single processor with a single-core, a single processor with multiple cores (e.g., a multi-core processor), multiple processors with a single core, multiple processors with multiples cores, or any combination thereof.

The memory 806 includes a main memory 816, a static memory 818, and a storage unit 820, both accessible to the processors 804 via the bus 810. The main memory 806, the static memory 818, and storage unit 820 store the instructions 802 embodying any one or more of the methodologies or functions described herein. The instructions 802 may also reside, completely or partially, within the main memory 816, within the static memory 818, within machine-readable medium 822 within the storage unit 820, within at least one of the processors 804 (e.g., within the processor's cache memory), or any suitable combination thereof, during execution thereof by the machine 800.

The I/O components 808 may include a wide variety of components to receive input, provide output, produce output, transmit information, exchange information, capture measurements, and so on. The specific I/O components 808 that are included in a particular machine will depend on the type of machine. For example, portable machines such as mobile phones may include a touch input device or other such input mechanisms, while a headless server machine will likely not include such a touch input device. It will be appreciated that the I/O components 808 may include many other components that are not shown in FIG. 8. In various examples, the I/O components 808 may include user output components 824 and user input components 826. The user output components 824 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 826 may include alphanumeric input components (e.g., a keyboard, a touch screen configured to receive alphanumeric input, video input (e.g., camera), peer-to-peer input (e.g., chatbot), a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 808 may include biometric components 828, motion components 830, environmental components 832, or position components 834, among a wide array of other components. The motion components 830 include acceleration sensor components (e.g., accelerometer), gravitation sensor components, rotation sensor components (e.g., gyroscope).

The environmental components 832 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gasses for safety or to measure pollutants in the atmosphere), or other components that may provide indications, measurements, or signals corresponding to a surrounding physical environment.

The position components 834 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 808 further include communication components 836 operable to couple the machine 800 to a network 838 or devices 840 via respective coupling or connections. For example, the communication components 836 may include a network interface component or another suitable device to interface with the network 838. In further examples, the communication components 836 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 840 may be another machine or any of a wide variety of peripheral devices (e.g., a peripheral device coupled via a USB).

Moreover, the communication components 836 may detect identifiers or include components operable to detect identifiers. For example, the communication components 836 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 836, such as location via Internet Protocol (IP) geolocation, location via Wi-Fi® signal triangulation, location via detecting an NFC beacon signal that may indicate a particular location, and so forth.

The various memories (e.g., main memory 816, static memory 818, and memory of the processors 804) and storage unit 820 may store one or more sets of instructions and data structures (e.g., software) embodying or used by any one or more of the methodologies or functions described herein. These instructions (e.g., the instructions 802), when executed by processors 804, cause various operations to implement the disclosed examples.

The instructions 802 may be transmitted or received over the network 838, using a transmission medium, via a network interface device (e.g., a network interface component included in the communication components 836) and using any one of several well-known transfer protocols (e.g., hypertext transfer protocol (HTTP)). Similarly, the instructions 802 may be transmitted or received using a transmission medium via a coupling (e.g., a peer-to-peer coupling) to the devices 840.

### Software Architecture

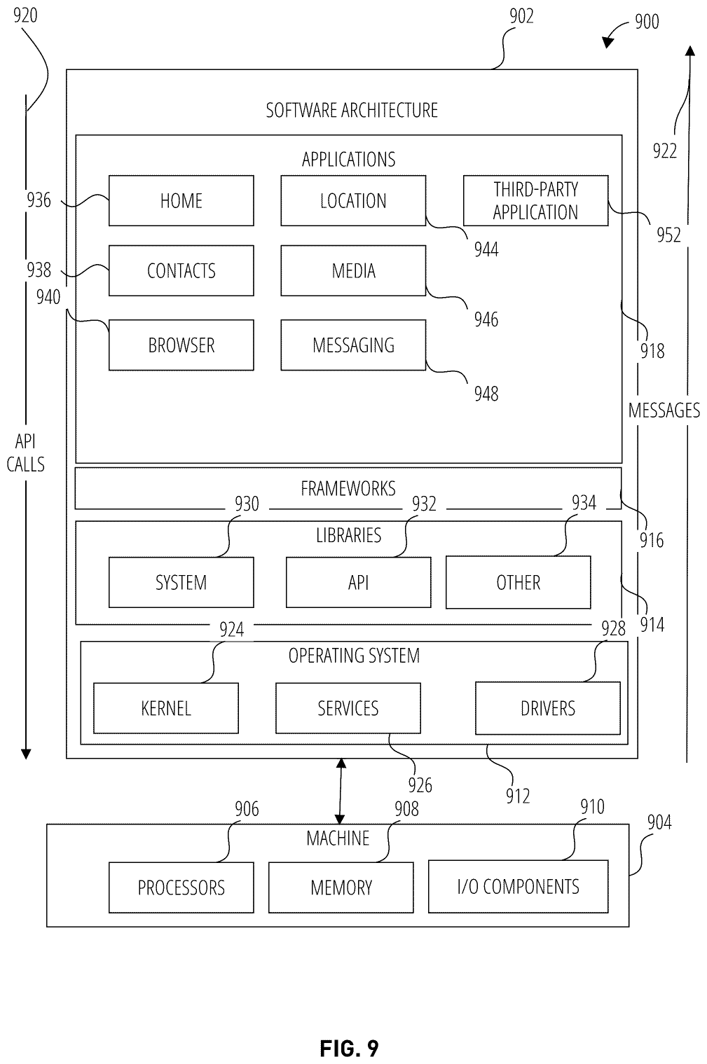

FIG. 9 is a block diagram 900 illustrating a software architecture 902, which can be installed on any one or more of the devices described herein. The software architecture 902 is supported by hardware such as a machine 904 that includes processors 906, memory 908, and I/O components 910. In this example, the software architecture 902 can be conceptualized as a stack of layers, where each layer provides a particular functionality. The software architecture 902 includes layers such as an operating system 912, libraries 914, frameworks 916, and applications 918. Operationally, the applications 918 invoke API calls 920 through the software stack and receive messages 922 in response to the API calls 920.

The operating system 912 manages hardware resources and provides common services. The operating system 912 includes, for example, a kernel 924, services 926, and drivers 928. The kernel 924 acts as an abstraction layer between the hardware and the other software layers. For example, the kernel 924 provides memory management, processor management (e.g., scheduling), component management, networking, and security settings, among other functionalities. The services 926 can provide other common services for the other software layers. The drivers 928 are responsible for controlling or interfacing with the underlying hardware. For instance, the drivers 928 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 914 provide a common low-level infrastructure used by the applications 918. The libraries 914 can include system libraries 930 (e.g., C standard library) that provide functions such as memory allocation functions, string manipulation functions, mathematic functions, and the like. In addition, the libraries 914 can include API libraries 932 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 914 can also include a wide variety of other libraries 934 to provide many other APIs to the applications 918.

The frameworks 916 provide a common high-level infrastructure that is used by the applications 918. For example, the frameworks 916 provide various graphical user interface (GUI) functions, high-level resource management, and high-level location services. The frameworks 916 can provide a broad spectrum of other APIs that can be used by the applications 918, some of which may be specific to a particular operating system or platform.

In an example, the applications 918 may include a home application 936, a contacts application 938, a browser application 940, a location application 944, a media application 946, a messaging application 948, and a broad assortment of other applications such as a third-party application 952. The applications 918 are programs that execute functions defined in the programs. Various programming languages can be employed to create one or more of the applications 918, structured in a variety of manners, such as object-oriented programming languages (e.g., Objective-C, Java, or C++) or procedural programming languages (e.g., C or assembly language). In a specific example, the third-party application 952 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 952 can invoke the API calls 920 provided by the operating system 912 to facilitate functionalities described herein.

### Machine-Learning Pipeline

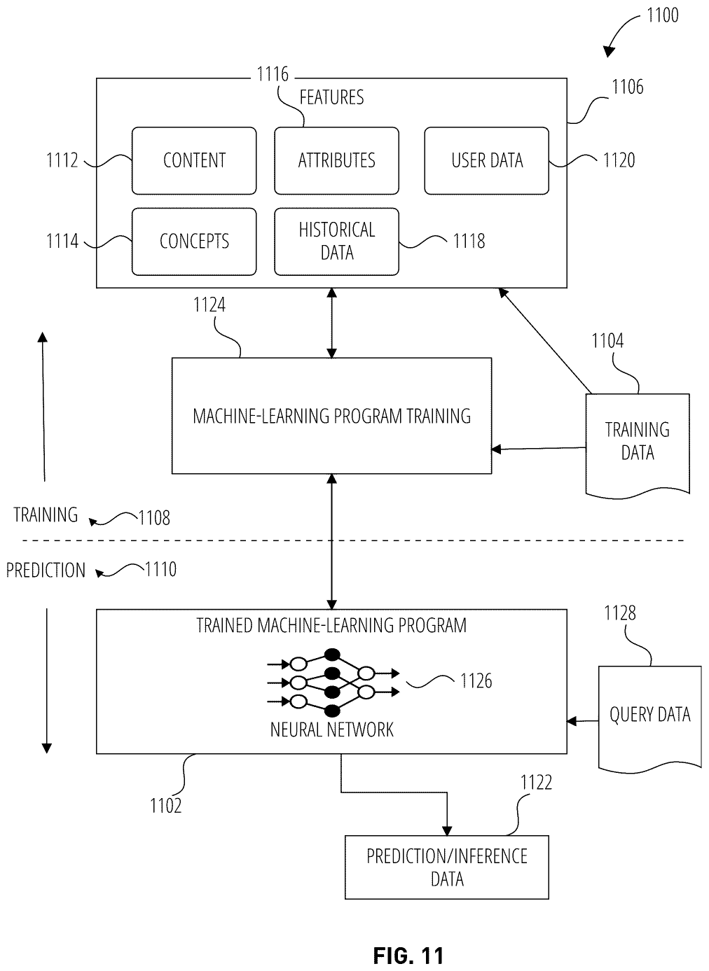

FIG. 11 is a flowchart depicting a machine-learning pipeline 1100, according to some examples. The machine-learning pipelines 1100 may be used to generate a trained model, for example the trained machine-learning program 1102 of FIG. 11, described herein to perform operations associated with searches and query responses.

### Overview

Broadly, machine learning may involve using computer algorithms to automatically learn patterns and relationships in data, potentially without the need for explicit programming to do so after the algorithm is trained. Examples of machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data. Evaluating the model on a separate test set helps to mitigate the risk of overfitting, a common issue in machine learning where a model learns to perform exceptionally well on the training data but fails to maintain that performance on data it hasn't encountered before. By using a test set, the system obtains a more reliable estimate of the model's real-world performance and its potential effectiveness when deployed in practical applications.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

### Phases

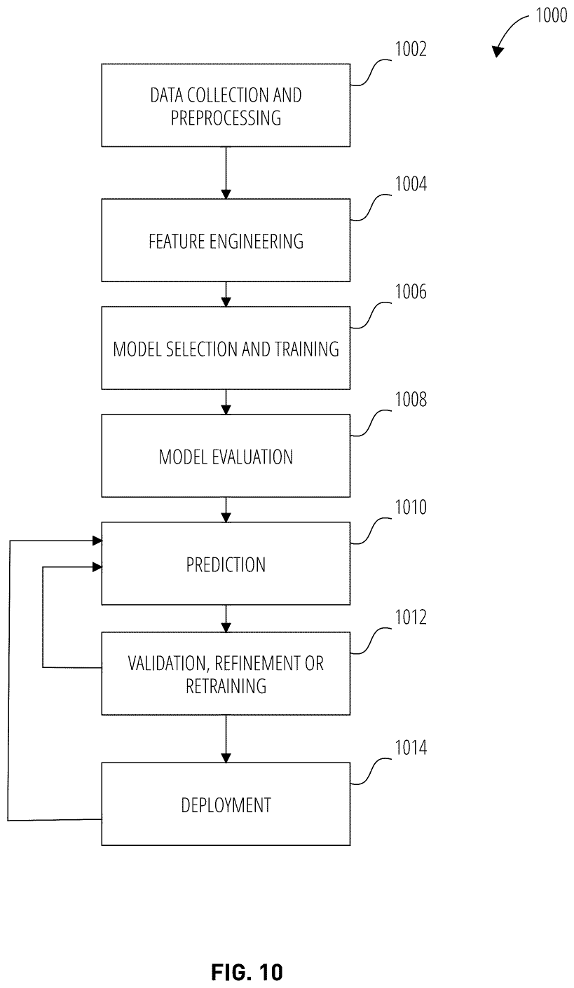

Generating a trained machine-learning program 1102 may include multiple types of phases that form part of the machine-learning pipeline 1100, including for example the following phases 1000 illustrated in FIG. 10:
Data collection and preprocessing 1002: This may include acquiring and cleaning data to ensure that it is suitable for use in the machine learning model. Data can be gathered from user content creation and labeled using a machine learning algorithm trained to label data. Data can be generated by applying a machine learning algorithm to identify or generate similar data. This may also include removing duplicates, handling missing values, and converting data into a suitable format.
Feature engineering 1004: This may include selecting and transforming the training data 1104 to create features that are useful for predicting the target variable. Feature engineering may include (1) receiving features 1106 (e.g., as structured or labeled data in supervised learning) and/or (2) identifying features 1106 (e.g., unstructured or unlabeled data for unsupervised learning) in training data 1104.
Model selection and training 1006: This may include specifying a particular problem or desired response from input data, selecting an appropriate machine learning algorithm, and training it on the preprocessed data. This may further involve splitting the data into training and testing sets, using cross-validation to evaluate the model, and tuning hyperparameters to improve performance. Model selection can be based on factors such as the type of data, problem complexity, computational resources, or desired performance.
Model evaluation 1008: This may include evaluating the performance of a trained model (e.g., the trained machine-learning program 1102) on a separate testing dataset. This can help determine if the model is overfitting or underfitting and if it is suitable for deployment.
Prediction 1010: This involves using a trained model (e.g., trained machine-learning program 1102) to generate predictions on new, unseen data.
Validation, refinement or retraining 1012: This may include updating a model based on feedback generated from the prediction phase, such as new data or user feedback.
Deployment 1014: This may include integrating the trained model (e.g., the trained machine-learning program 1102) into a larger system or application, such as a web service, mobile app, or IoT device. This can involve setting up APIs, building a user interface, and ensuring that the model is scalable and can handle large volumes of data.

FIG. 11 illustrates two example phases, namely a training phase 1108 (part of the model selection and trainings 1006) and a prediction phase 1110 (part of prediction 1010). Prior to the training phase 1108, feature engineering 1004 is used to identify features 1106. This may include identifying informative, discriminating, and independent features for the effective operation of the trained machine-learning program 1102 in pattern recognition, classification, and regression. In some examples, the training data 1104 includes labeled data, which is known data for pre-identified features 1106 and one or more outcomes.

Each of the features 1106 may be a variable or attribute, such as individual measurable property of a process, article, system, or phenomenon represented by a data set (e.g., the training data 1104). Features 1106 may also be of different types, such as numeric features, strings, vectors, matrices, encodings, and graphs, and may include one or more of content 1112, concepts 1114, attributes 1116, historical data 1118 and/or user data 1120, merely for example. Concept features can include abstract relationships or patterns in data, such as determining a topic of a document or discussion in a chat window between users. Content features include determining a context based on input information, such as determining a context of a user based on user interactions or surrounding environmental factors. Context features can include text features, such as frequency or preference of words or phrases, image features, such as pixels, textures, or pattern recognition, audio classification, such as spectrograms, and/or the like. Attribute features include intrinsic attributes (directly observable) or extrinsic features (derived), such as identifying square footage, location, or age of a real estate property identified in a camera feed. User data features include data pertaining to a particular individual or to a group of individuals, such as in a geographical location or that share demographic characteristics. User data can include demographic data (such as age, gender, location, or occupation), user behavior (such as browsing history, purchase history, conversion rates, click-through rates, or engagement metrics), or user preferences (such as preferences to certain video, text, or digital content items). Historical data includes past events or trends that can help identify patterns or relationships over time.

In training phases 1108, the machine-learning pipeline 1100 uses the training data 1104 to find correlations among the features 1106 that affect a predicted outcome or prediction/inference data 1122.

With the training data 1104 and the identified features 1106, the trained machine-learning program 1102 is trained during the training phase 1108 during machine-learning program training 1124. The machine-learning program training 1124 appraises values of the features 1106 as they correlate to the training data 1104. The result of the training is the trained machine-learning program 1102 (e.g., a trained or learned model).

Further, the training phase 1108 may involve machine learning, in which the training data 1104 is structured (e.g., labeled during preprocessing operations), and the trained machine-learning program 1102 implements a relatively simple neural network 1126 capable of performing, for example, classification and clustering operations. In other examples, the training phase 1108 may involve deep learning, in which the training data 1104 is unstructured, and the trained machine-learning program 1102 implements a deep neural network 1126 that is able to perform both feature extraction and classification/clustering operations.

A neural network 1126 may, in some examples, be generated during the training phase 1108, and implemented within the trained machine-learning program 1102. The neural network 1126 includes a hierarchical (e.g., layered) organization of neurons, with each layer including multiple neurons or nodes. Neurons in the input layer receive the input data, while neurons in the output layer produce the final output of the network. Between the input and output layers, there may be one or more hidden layers, each including multiple neurons.

Each neuron in the neural network 1126 operationally computes a small function, such as an activation function that takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, which can affect their performance on different tasks. Overall, the layered organization of neurons and the use of activation functions and weights enable neural networks to model complex relationships between inputs and outputs, and to generalize to new inputs that were not seen during training.

In some examples, the neural network 1126 may also be one of a number of different types of neural networks or a combination thereof, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 1108, a validation phase may be performed evaluated on a separate dataset known as the validation dataset. The validation dataset is used to tune the hyperparameters of a model, such as the learning rate and the regularization parameter. The hyperparameters are adjusted to improve the performance of the model on the validation dataset.

The neural network 1126 is iteratively trained by adjusting model parameters to minimize a specific loss function or maximize a certain objective. The system can continue to train the neural network 1126 by adjusting parameters based on the output of the validation, refinement, or retraining block 1012, and rerun the prediction 1010 on new or already run training data. The system can employ optimization techniques for these adjustments such as gradient descent algorithms, momentum algorithms, Nesterov Accelerated Gradient (NAG) algorithm, and/or the like. The system can continue to iteratively train the neural network 1126 even after deployment 1014 of the neural network 1126. The neural network 1126 can be continuously trained as new data emerges, such as based on user creation or system-generated training data.

Once a model is fully trained and validated, in a testing phase, the model may be tested on a new dataset that the model has not seen before. The testing dataset is used to evaluate the performance of the model and to ensure that the model has not overfit the training data.

In prediction phase 1110, the trained machine-learning program 1102 uses the features 1106 for analyzing query data 1128 to generate inferences, outcomes, or predictions, as examples of a prediction/inference data 1122. For example, during prediction phase 1110, the trained machine-learning program 1102 is used to generate an output. Query data 1128 is provided as an input to the trained machine-learning program 1102, and the trained machine-learning program 1102 generates the prediction/inference data 1122 as output, responsive to receipt of the query data 1128. Query data can include a prompt, such as a user entering a textual question or speaking a question audibly. In some cases, the system generates the query based on an interaction function occurring in the system, such as a user interacting with a virtual object, a user sending another user a question in a chat window, or an object detected in a camera feed.

In some examples the trained machine-learning program 1102 may be a generative AI model. Generative AI is a term that may refer to any type of artificial intelligence that can create new content from training data 1104. For example, generative AI can produce text, images, video, audio, code or synthetic data that are similar to the original data but not identical.

Some of the techniques that may be used in generative AI are:
Convolutional Neural Networks (CNNs): CNNs are commonly used for image recognition and computer vision tasks. They are designed to extract features from images by using filters or kernels that scan the input image and highlight important patterns. CNNs may be used in applications such as object detection, facial recognition, and autonomous driving.
Recurrent Neural Networks (RNNs): RNNs are designed for processing sequential data, such as speech, text, and time series data. They have feedback loops that allow them to capture temporal dependencies and remember past inputs. RNNs may be used in applications such as speech recognition, machine translation, and sentiment analysis
Generative adversarial networks (GANs): These are models that consist of two neural networks: a generator and a discriminator. The generator tries to create realistic content that can fool the discriminator, while the discriminator tries to distinguish between real and fake content. The two networks compete with each other and improve over time. GANs may be used in applications such as image synthesis, video prediction, and style transfer.
Variational autoencoders (VAEs): These are models that encode input data into a latent space (a compressed representation) and then decode it back into output data. The latent space can be manipulated to generate new variations of the output data. They may use self-attention mechanisms to process input data, allowing them to handle long sequences of text and capture complex dependencies.
Transformer models: These are models that use attention mechanisms to learn the relationships between different parts of input data (such as words or pixels) and generate output data based on these relationships. Transformer models can handle sequential data such as text or speech as well as non-sequential data such as images or code.

In generative AI examples, the prediction/inference data 1122 that is output include trend assessment and predictions, translations, summaries, image or video recognition and categorization, natural language processing, face recognition, user sentiment assessments, advertisement targeting and optimization, voice recognition, or media content generation, recommendation, and personalization.

### Usage Cases for Tokenization, Ownership, Use, and/or the Like

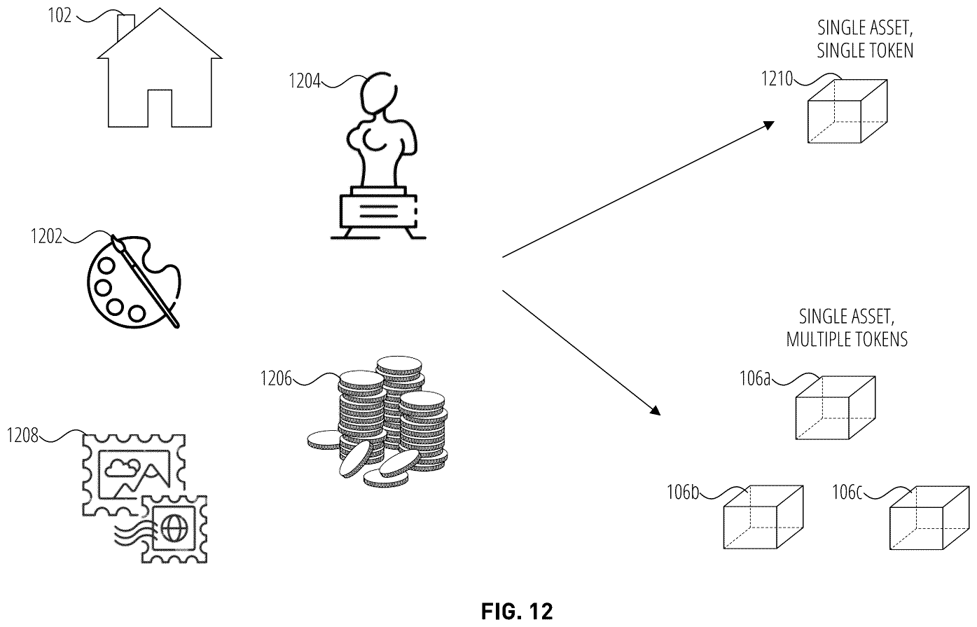

FIG. 12 illustrates tokenization of an asset as a whole, according to some examples. In some cases, a real world asset is not divided into parts by the tokenization system. For example, a home 102 is tokenized as a whole and not divided into different rooms. In some cases, the tokenization system tokenizes assets that are not easily dividable without changing the asset itself, such as a sculpture 1204, a painting 1202, a stamp in a stamp collection 1208, a coin in a rare coin collection 1206, and/or the like.

In some cases, the tokenization system generates and/or mints a single token 1210 corresponding to ownership or usage rights for the individual asset. In other cases, the tokenization system generates and/or mints multiple tokens 106a, 106b, 106c representing fractional ownership and/or different usage rights for the individual asset.

As users gain ownership and/or usage rights for the individual asset, users can start utilizing the asset as per the agreement and/or contractual terms (as further described herein).

In some cases, asset owners can jointly tokenize assets. For example, the artist and sculptor can jointly tokenize their paintings and sculptures. The joint assets can be tokenized either into a single token or multiple tokens. In some cases, the individual assets are valuated and tokens are assigned respectively. In other cases, a single token provides ownership and/or usage of the joint assets.

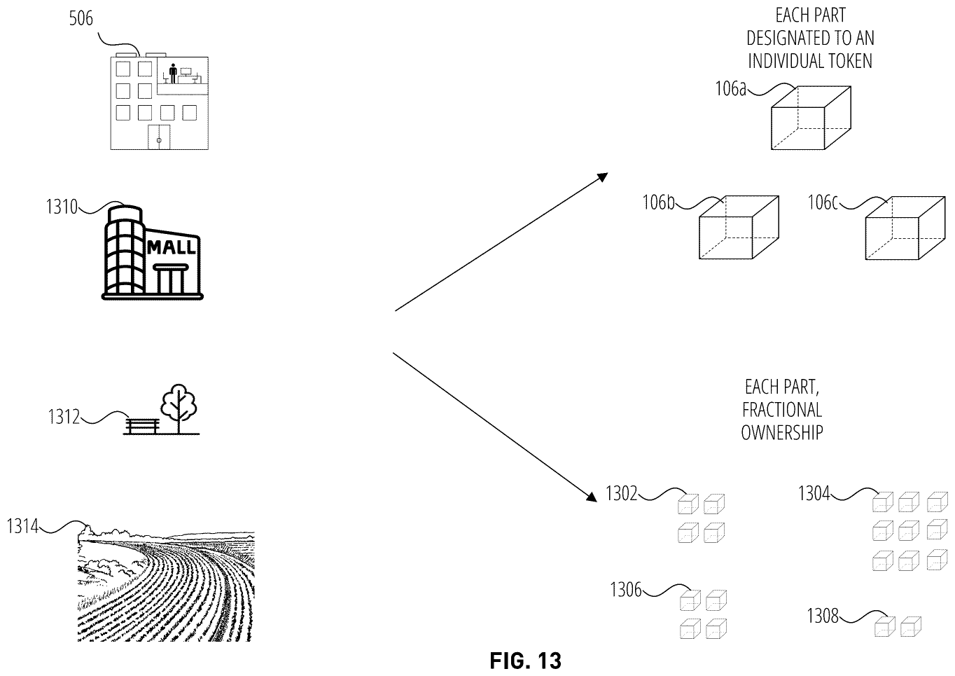

FIG. 13 illustrates tokenization of an asset that is divisible into parts, according to some examples. The tokenization system can divide an asset, such as a building 506, a mall 1310, a park 1312, farm land 1314, into parts and tokenize individual parts for use and/or ownership. For example, a building can be divided into apartments, a mall can be divided into sections for stores, farm land divided into parcels, and/or the like.

In some cases, the tokenization system generates an individual usage and/or ownership token for each divisible part, such as token 106a for a first apartment unit, token 106b for a second apartment unit, and 106c for a third apartment unit. In other cases, the tokenization system generates multiple tokens for each part. such as tokens 1302 for a first store front, tokens 1304 for a second store front, tokens 1306 for a third store front, tokens 1308 for a fourth store front and/or the like. In some cases, the amount of tokens for each part is determined using the valuation methods and processes as further described herein.

In some cases, the tokenization system identifies divisible parts based on third party data, such as data on the number of units in an apartment building retrieved from a real estate or government website. In some cases, the tokenization system applies a machine learning model that is trained to automatically determine divisible portions of a particular asset. For example, the machine learning model can receive as input an address of an asset, a type of asset (such as if the asset type indicates a divisible number of parts such as a duplex), input from the asset owner of characteristics of the asset, and/or the like (other inputs to the machine learning model further described herein).

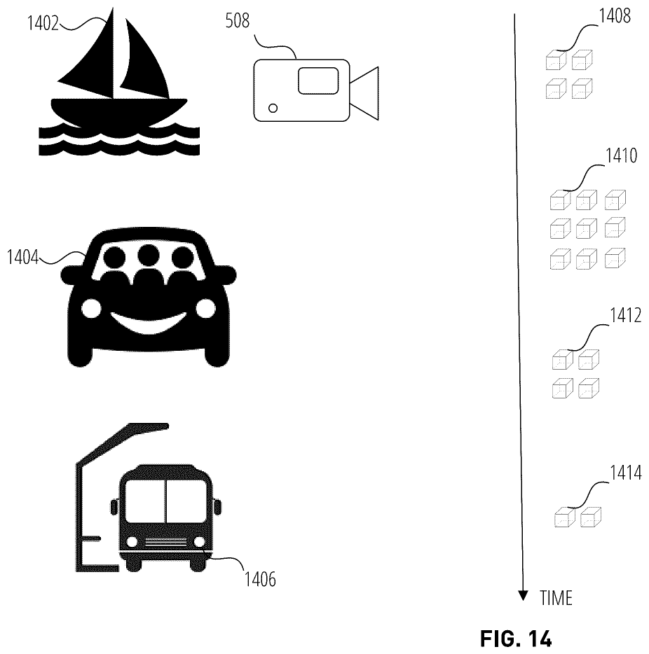

FIG. 14 illustrates tokenizing ownership and/or usage across time, according to some examples. In some cases, the tokenization system can tokenize an asset, such as a boat 1402, equipment 508, car 1404, public transportation 1406, and/or the like over time. The tokenization system applies ownership and/or usage rights over time. For example, a boat 1402 can be rented throughout the year for the use in boat tours.

The tokenization system can generate tokens according to the time and/or time frame desired for ownership and/or usage. For example, the tokenization system determines that boat tours are in demand in certain parts of the year but not in others. The tokenization system can apply the valuation methods and processes as further described herein to value the ownership and/or usage for particular time periods. For example, the time frame for tokens 1410 are in high demand, and thus more tokens are required for ownership and/or usage for these time slots, whereas the time periods for tokens 1408, 1412, and 1414 are in less demand and thus less tokens are minted for these time periods.

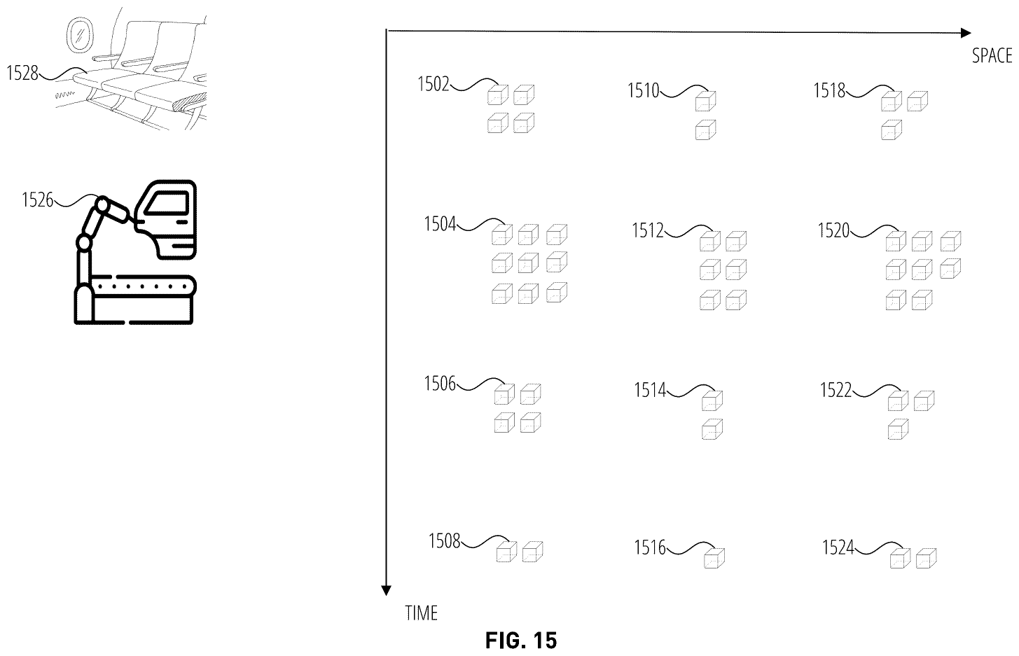

FIG. 15 illustrate tokenizing ownership and/or usage across time and parts, according to some examples. In some cases, the tokenization system tokenizes an asset across time and space. For example, the tokenization system divides an airplane 1528 into multiple seats or a multiple factory production lines in a factory 1526.

An airplane can have tens or hundreds of seats, each of which could be tokenized. In some cases, a group of seats can be tokenized, such as 4 seats for a family of 4. Such tokens can be tied to a particular airplane or to an airline with a fleet of airplanes.

In some cases, the tokenization system tokenizes ownership and/or usage across multiple factors, such as time and parts. It is appreciated that the tokenization system can tokenize an asset across one or more other factors, such as time and location, time parts and location, and/or the like.

As noted herein, the tokenization system can determine a valuation for the token based on these factors. In FIG. 15, the tokenization system determines that the certain seats at a particular time frame corresponding to tokens 1504 and 1520 are the highest in demand or highest in cost. As such, the more tokens are minted for the seats and time corresponding to tokens 1504 and 1520 than that for tokens 1502, 1510, 1518, 1512, 1506, 1514, 1522, 1508, 1516, and 1524.

In some cases, a factory with multiple production lines can tokenize each production line over different periods of time. Ownership of Tokens allow for the usage of associated production lines and collection of proceeds from the product line output. In some cases, a livestock production facility can tokenize each production line and across multiple cycles within a calendar year and offer those tokens to individual operators. These operators can make use of the facility for their own production and/or further offer the production line to other operators who could make use of the facility.

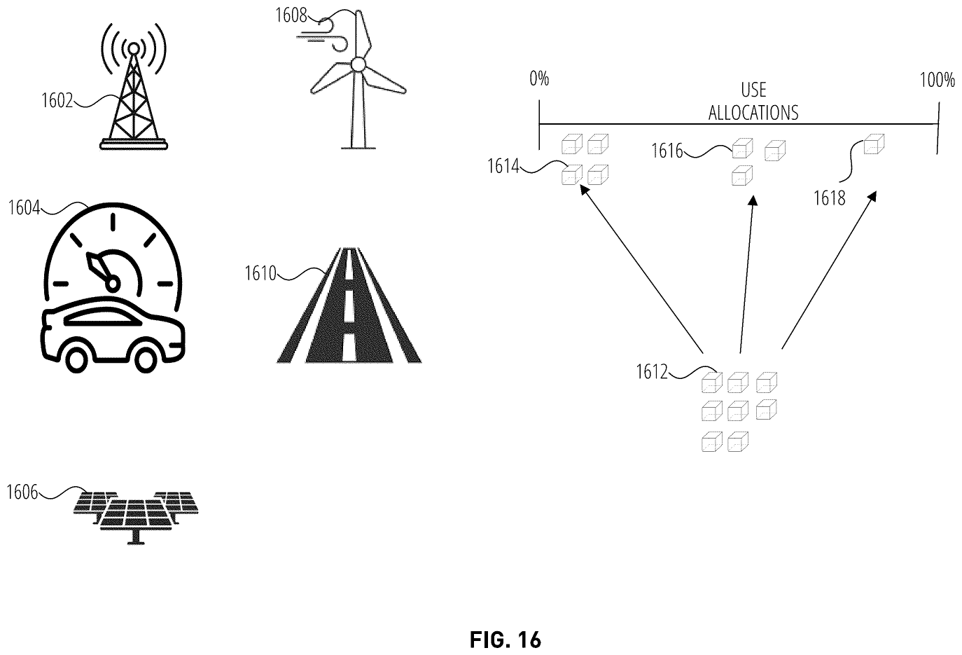

FIG. 16 illustrates tokenization for use allocations, according to some examples. The tokenization system can tokenize use allocations for assets. The tokenization system can tokenize cellphone towers 1602 such as based on data bandwidth usage. The tokenization system can tokenize amount of electricity generation by a wind turbine 1608 or solar farms 1606. The tokenization system can tokenize automobiles 1604 based on mileage. The tokenization system can tokenize use of roads 1610, such as an amount of traffic or length of travel.

Use allocations can be uniform across use, such as allocating the same amount of tokens for use of an automobile from 0-10 miles, 10-20 miles, 20-30 miles, etc. As shown in FIG. 16, use allocations can be different across use allocations. The automobile can be equivalent to a total token group 1612. However the use of the automobile may be of a higher value when the automobile is new. As such, the first group of miles for the automobile may be worth more tokens, such as tokens 1614, than when the automobile is at the middle of its lifespan, such as tokens 1616, or the end of its lifespan, such as token 1618.

In some cases, the tokenization system tokenizes cellphone towers (e.g., data use), automobile or farm equipment (e.g., mileage), oil wells, solar farms, wind turbines, other energy sources, mining rights, water rights, fishing quotas, bridges, toll roads, public transport, locations with services (e.g., fitness center, copy center, restaurant), and/or the like.

The tokenization system can tokenize an internet provider based on a provided bandwidth. The tokenization system can generate tokens representative of portions of bandwidth usage and provide such tokens to a large user base or virtual providers. The owners of these tokens can then use the associated bandwidth or sell the bandwidth to other users. A geographically diverse shared electricity grid can also tokenize its production of electricity and offer tokens to individual electricity producers that best meet the demands of their customers. Both these examples demonstrate the ability of the tokenization system to improve utilization of temporal assets that would be lost if not used immediately.

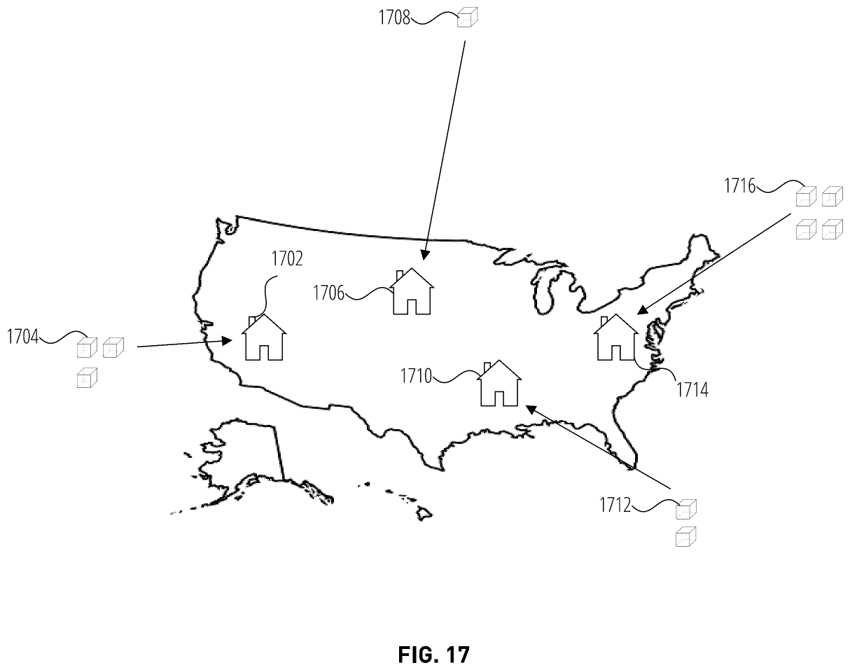

FIG. 17 illustrates token generation based on location, according to some examples. In some cases, the tokenization system tokenizes homes 1702, 1706, 1710, and 1714. Depending on the location of the home, the home may be valued differently. The tokenization system takes into consideration location, and/or other characteristics as described further herein in the valuation model, to determine a number of tokens to generate for the home. For example, home 1702 is provided with 3 tokens 1704, home 1706 is provided with 1 token 1708, home 1710 is provided with 2 tokens 1712, and home 1714 is provided with 4 tokens 1716.

In some cases, the tokenization system tokenizes medical facilities, clinics, wellness centers, companies (legal practices, accounting firms, consulting firms, research centers, etc.), and/or the like based on at least location.

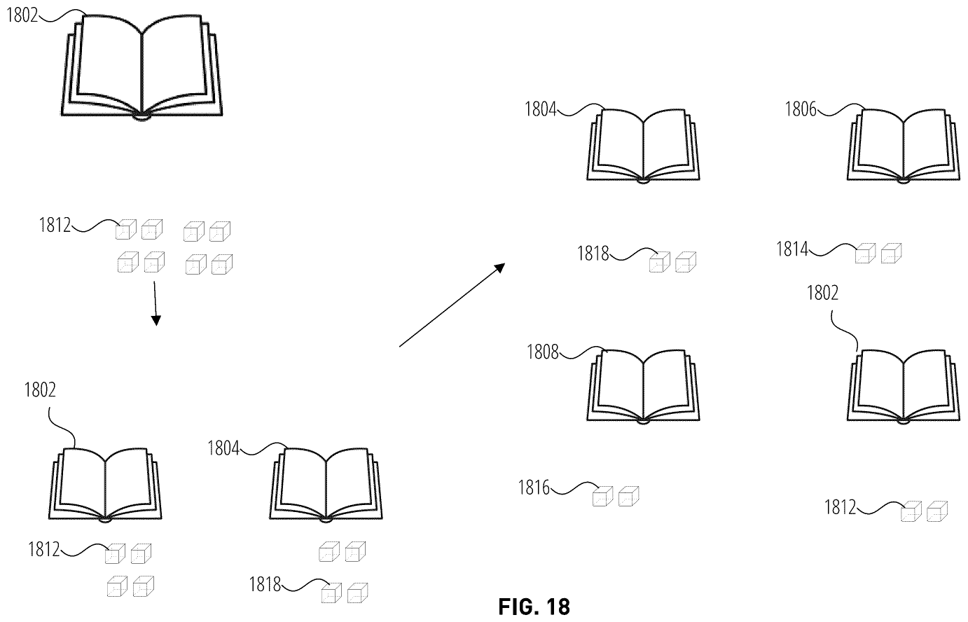

FIG. 18 illustrates token generation for copies of goods, according to some examples. In some cases, the tokenization system tokenizes copies of goods, such as artwork, creative works, books, movies, designs, architectural plans, educational content, music, software, formulas, recipes, advertisements, intellectual property, machine learning models, virtual objects (objects in virtual reality, augmented reality, mixed reality, etc), in-game items, in-application items, pharmaceuticals, and/or the like.

In some cases, as more copies are made, the more tokens are generated and/or the reduction of value for each token. For example, a book 1802 without any copies can be equivalent to 8 tokens 1812. The tokenization system can generate a first copy 1804 of the book and with the generated first copy, divide the number of tokens (e.g., tokens 1812, 1814) equally between the original book 1802 and the first copy 1804. As such, the owner can decide how many copies to generate and how granular the owner desires the tokens and asset to be sold. In the next step, second copy 1806 and third copy 1808 are generated, and the tokenization system generates tokens 1818 and 1816 respectively. As shown in FIG. 18, after there are 4 copies in existence, the value for each book is reduced from 8 tokens down to 2 tokens each.

Although particular examples are described herein, such as a home being non-divisible and tokenized, it is appreciated that the example assets described herein can be applied to other types of tokenization. For example, the home 102 can be tokenized for usage across time, such as a short term rental.

The previous use cases can be combined whereby different features can be obtained from each case. This allows for a large amount of flexibility according to the underlying assets and intended usage. For example, the tokenization system can use the same tokens for different assets enabling flexibility in exchange of assets. For example, the tokenization system can apply tokens from a token owner issued by the same asset owner for use of different assets even if the assets are different or have different usage models.

Assets can be owned by a single or multiple asset owners. An asset owner can have a single or multiple assets. Assets can be used by a single or multiple tenants simultaneously. Asset usage can span a single or multiple time periods. A tenant may be allowed to utilize the asset for themselves only or offer it to be utilized by others. Intermediaries can borrow Tokens and acquire some asset ownership rights to offer the assets to other tenants. Asset utilization returns are shared with all token owners and potentially a portion of tenant returns. The asset itself can be made eligible for ownership if enough tokens are owned by a tenant.

As further described herein, the ownership and/or usage can be on a first come first serve basis, the tokenization system can implement a bidding auction whereby users can bid tokens and/or payments for a certain ownership or usage of an asset, and/or the like.

### EXAMPLES

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: at least one processor; and at least one memory component storing instructions that, when executed by the at least one processor, cause the at least one processor to perform operations comprising: receiving a first physical commodity ownership record document for a physical commodity from a physical commodity holder; identifying a value of the physical commodity; generating a plurality of fractionalized property tokens corresponding to the value of the physical commodity based on the value and a value for each fractionalized property token, each fractionalized property token representing a fractional ownership interest in the physical commodity; transmitting the generated fractionalized property tokens to a tokenized account associated with the physical commodity holder; receiving a first token resource allocation by a first physical commodity acquirer; determining a first number of fractionalized property tokens corresponding to the value of the first token resource allocation; transmitting the first number of fractionalized property tokens from the tokenized account associated with the physical commodity holder to the tokenized account associated with the first physical commodity acquirer; and generating a second physical commodity ownership record document indicating fractional ownership by the physical commodity holder and the first physical commodity acquirer.

In Example 2, the subject matter of Example 1 includes, wherein the operations further comprise: receiving a second token resource allocation by a second physical commodity acquirer; determining a second number of fractionalized property tokens corresponding to the value of the second token resource allocation; transmitting the second number of fractionalized property tokens from the tokenized account associated with the physical commodity holder to the tokenized account associated with the second physical commodity acquirer; and generating a third physical commodity ownership record document indicating fractional ownership by the physical commodity holder, the first physical commodity acquirer, and the second physical commodity acquirer.

In Example 3, the subject matter of Examples 1-2 includes, wherein generating the second physical commodity ownership record document indicating fractional ownership by the physical commodity holder and the first physical commodity acquirer is in response to determining a remaining number of fractionalized property tokens in the tokenized account associated with the physical commodity holder.

In Example 4, the subject matter of Examples 1-3 includes, wherein the operations further comprise: receiving a second token resource allocation; determining a second number of fractionalized property tokens corresponding to the value of the second token resource allocation; transmitting the second number of fractionalized property tokens from the tokenized account associated with the physical commodity holder to another tokenized account; determining that tokenized account associated with the physical commodity holder does not include fractionalized property tokens for the physical commodity; and generating a third physical commodity ownership record document removing ownership by the physical commodity holder.

In Example 5, the subject matter of Example 4 includes, wherein the operations further comprise: in response to generating a third physical commodity ownership record document removing ownership by the physical commodity holder, purging the fractionalized property tokens corresponding from a circulating supply of fractionalized property tokens.

In Example 6, the subject matter of Examples 1-5 includes, wherein generating the second physical commodity ownership record document comprises generating the second physical commodity ownership record document using a machine learning model, wherein the machine learning model is trained to generate physical commodity ownership record documents based on one or more prior physical commodity ownership record documents for the same physical commodity.

In Example 7, the subject matter of Examples 1-6 includes, wherein generating the plurality of fractionalized property tokens comprises initiating generation of the plurality of fractionalized property tokens by a group of nodes of a blockchain, wherein the operations further comprise: initiating recordation of the generation of the plurality of fractionalized property tokens onto a distributed ledger of the blockchain, wherein the operations further comprise recording a transfer of the first physical commodity ownership record document from the physical commodity holder to the system on the distributed ledger.

In Example 8, the subject matter of Examples 1-7 includes, wherein the physical commodity includes a real estate property, the first physical commodity ownership record document including a digitized deed, and the physical commodity holder including a real estate property owner, and the first physical commodity acquirer including a real estate property purchaser.

In Example 9, the subject matter of Examples 1-8 includes, wherein the operations further comprise: performing optical character recognition (OCR) on the first physical commodity ownership record document, and converting data identified from performing the OCR into a standardized format, identifying the value of the physical commodity being based on the converted data.

In Example 10, the subject matter of Examples 1-9 includes, wherein the operations further comprise: providing the first physical commodity acquirer with access to the physical commodity.

In Example 11, the subject matter of Example 10 includes, the system provides the first physical commodity acquirer with access to the physical commodity by generating a unique access code for a digital lock or security system of the physical commodity.

In Example 12, the subject matter of Examples 10-11 includes, the system provides the first physical commodity acquirer with access to the physical commodity by transmitting a signal to one or more Internet of Things (IoT) devices associated with the physical commodity such that the one or more IoT devices grants access to the first physical commodity acquirer.

In Example 13, the subject matter of Examples 10-12 includes, the system provides the first physical commodity acquirer with access to the physical commodity by automatically booking the physical commodity for the first physical commodity acquirer for a first tokenized tenure.

In Example 14, the subject matter of Examples 1-13 includes, wherein the physical commodity includes a collection of physical properties, wherein the first physical commodity acquirer is able to access one of the physical properties, wherein the tokens represent fractional ownership for the collection of the physical properties, wherein the value of the tokens required for the transfer of ownership is the value of the collection of the physical properties.

In Example 15, the subject matter of Examples 1-14 includes, wherein the operations further comprise: receiving a first digital signature from the first physical commodity acquirer and a second digital signature from the physical commodity holder prior to recording a transfer for the first physical commodity ownership record between the first physical commodity holder to the first physical commodity acquirer.

In Example 16, the subject matter of Examples 1-15 includes, wherein the at least one processor is configured to apply the first physical commodity ownership record document to a machine learning model, wherein the machine learning model perform the operations of identifying the value of the physical commodity, generating the plurality of fractionalized property tokens corresponding to the value of the physical commodity based on the value and the value for each fractionalized property token, and transmitting the generated fractionalized property tokens to the tokenized account associated with the physical commodity holder.

In Example 17, the subject matter of Examples 1-16 includes, wherein the at least one processor is configured to apply the first token resource allocation to a machine learning model, wherein the machine learning model perform the operations of determining a first number of fractionalized property tokens corresponding to the value of the first token resource allocation, transmitting the first number of fractionalized property tokens from the tokenized account associated with the physical commodity holder to the tokenized account associated with the first physical commodity acquirer, and generating a second physical commodity ownership record document indicating fractional ownership by the physical commodity holder and the first physical commodity acquirer.

In Example 18, the subject matter of Examples 1-17 includes, the operations further comprising: receiving a second physical commodity ownership record document for a second physical commodity from the physical commodity holder, wherein generating the plurality of fractionalized property tokens further comprises generating a number of fractionalized property tokens corresponding to the value of the physical commodity and the second physical commodity.

In Example 19, the subject matter of Examples 1-18 includes, the operations further comprising: receiving a second physical commodity ownership record document for a second physical commodity from a second physical commodity holder, wherein generating the plurality of fractionalized property tokens further comprises generating a number of fractionalized property tokens corresponding to the value of the physical commodity and the second physical commodity.

Example 20 is a method comprising: receiving a first physical commodity ownership record document for a physical commodity from a physical commodity holder; identifying a value of the physical commodity; generating a plurality of fractionalized property tokens corresponding to the value of the physical commodity based on the value and a value for each fractionalized property token, each fractionalized property token representing a fractional ownership interest in the physical commodity; transmitting the generated fractionalized property tokens to a tokenized account associated with the physical commodity holder; receiving a first token resource allocation by a first physical commodity acquirer; determining a first number of fractionalized property tokens corresponding to the value of the first token resource allocation; transmitting the first number of fractionalized property tokens from the tokenized account associated with the physical commodity holder to the tokenized account associated with the first physical commodity acquirer; and generating a second physical commodity ownership record document indicating fractional ownership by the physical commodity holder and the first physical commodity acquirer.

Example 21 is a non-transitory computer-readable storage medium storing instructions that, when executed by at least one processor, cause the at least one processor to perform operations comprising: receiving a first physical commodity ownership record document for a physical commodity from a physical commodity holder; identifying a value of the physical commodity; generating a plurality of fractionalized property tokens corresponding to the value of the physical commodity based on the value and a value for each fractionalized property token, each fractionalized property token representing a fractional ownership interest in the physical commodity; transmitting the generated fractionalized property tokens to a tokenized account associated with the physical commodity holder; receiving a first token resource allocation by a first physical commodity acquirer; determining a first number of fractionalized property tokens corresponding to the value of the first token resource allocation; transmitting the first number of fractionalized property tokens from the tokenized account associated with the physical commodity holder to the tokenized account associated with the first physical commodity acquirer; and generating a second physical commodity ownership record document indicating fractional ownership by the physical commodity holder and the first physical commodity acquirer.

Example 22 is at least one machine-readable medium including instructions that, when executed by processing circuitry, cause the processing circuitry to perform operations to implement any of Examples 1-21.

Example 23 is an apparatus comprising means to implement of any of Examples 1-21.

Example 24 is a system to implement any of Examples 1-21.

Example 25 is a method to implement any of Examples 1-21.

Although examples described herein describe features of the tokenization system using a digitized asset rights document, it is appreciated that the features of the tokenization system can apply to other forms, such as real world property ownership certificate, digital physical property title, digitized asset rights, document, physical asset registry record, physical commodity ownership record document, real estate ownership certificate, real estate possession record, tangible asset ownership record, tangible property conveyance document, deed, title, and/or the like, and/or vice versa.

Although examples described herein describe features of the tokenization system using a real world asset, it is appreciated that the features of the tokenization system can apply to other forms, such as real world property, physical property, tangible property, physical commodity, real estate property, physical asset, real estate, tangible asset, real world asset, and/or the like, and/or vice versa.

Although examples described herein describe features of the tokenization system using an asset holder, it is appreciated that the features of the tokenization system can apply to other forms, such as real world property owner, physical property owner, tangible property owner, physical commodity holder, real estate property proprietor, physical asset possessor, real estate possessor, tangible asset custodian, and/or the like, and/or vice versa.

Although examples described herein describe features of the tokenization system using an asset utilizer, it is appreciated that the features of the tokenization system can apply to other forms, such as real world property user, physical property user, tangible property occupant, physical commodity occupier, real estate property utilizer, physical asset acquirer, real estate user, tangible asset renter, and/or the like, and/or vice versa.

Although examples described herein describe features of the tokenization system using a physical commodity acquirer, it is appreciated that the features of the tokenization system can apply to other forms, such as real estate recipient, tangible asset procurer, and/or the like, and/or vice versa.

Although examples described herein describe features of the tokenization system using a digital tokens, it is appreciated that the features of the tokenization system can apply to other forms, such as digital rights tokens, virtual asset units, electronic ownership tokens, fractionalized property token, digital real estate property token, physical asset digital ledger coins, asset-backed tokens, and/or the like, and/or vice versa.

Although examples described herein describe features of the tokenization system using a digital wallet, it is appreciated that the features of the tokenization system can apply to other forms, such as digital rights token storage, virtual asset storage, electronic token data repository, tokenized account, digital Token repository, digital ledger wallet, digital token storage, virtual token storage, and/or the like, and/or vice versa.

Although examples described herein describe features of the tokenization system using an asset transaction, it is appreciated that the features of the tokenization system can apply to other forms, such as remittance, virtual asset relocation, tokenized exchange, token resource allocation, token provision, digital ledger coin transfer, digital token relocation, token disbursement, asset transaction, digital token relocation, and/or the like, and/or vice versa. Moreover, the tokens in the token disbursement, relocation, remittance, exchange, provisions and/or the like described herein can be different tokens than the tokens that represent usage rights or ownership rights.

Although examples described herein describe features of the tokenization system using an asset utilization period, it is appreciated that the features of the tokenization system can apply to other forms, such as real world property use term, physical property utilization period, occupancy span, tokenized tenure, physical asset use duration, real estate utilization period, and/or the like, and/or vice versa.

### CONCLUSION

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

The various features, steps, and processes described herein may be used independently of one another, or may be combined in various ways. All possible combinations and subcombinations are intended to fall within the scope of this disclosure. In addition, certain method or process blocks may be omitted in some implementations.

What is claimed is:

1. A system comprising:
at least one processor; and
at least one memory component storing instructions that, when executed by the at least one processor, cause the at least one processor to perform operations comprising:
receiving a first physical commodity ownership record document for a physical commodity from a physical commodity holder;
identifying a value of the physical commodity;
generating a plurality of fractionalized property tokens corresponding to the value of the physical commodity based on the value and a value for each fractionalized property token, each fractionalized property token representing a fractional ownership interest in the physical commodity;
transmitting the generated fractionalized property tokens to a tokenized account associated with the physical commodity holder;
receiving a first token resource allocation by a first physical commodity acquirer;
determining a first number of fractionalized property tokens corresponding to the value of the first token resource allocation;
transmitting the first number of fractionalized property tokens from the tokenized account associated with the physical commodity holder to the tokenized account associated with the first physical commodity acquirer; and
generating a second physical commodity ownership record document indicating fractional ownership by the physical commodity holder and the first physical commodity acquirer.

2. The system of claim 1, wherein the operations further comprise:
receiving a second token resource allocation by a second physical commodity acquirer;
determining a second number of fractionalized property tokens corresponding to the value of the second token resource allocation;
transmitting the second number of fractionalized property tokens from the tokenized account associated with the physical commodity holder to the tokenized account associated with the second physical commodity acquirer; and
generating a third physical commodity ownership record document indicating fractional ownership by the physical commodity holder, the first physical commodity acquirer, and the second physical commodity acquirer.

3. The system of claim 1, wherein generating the second physical commodity ownership record document indicating fractional ownership by the physical commodity holder and the first physical commodity acquirer is in response to determining a remaining number of fractionalized property tokens in the tokenized account associated with the physical commodity holder.

4. The system of claim 1, wherein the operations further comprise:
receiving a second token resource allocation;
determining a second number of fractionalized property tokens corresponding to the value of the second token resource allocation;
transmitting the second number of fractionalized property tokens from the tokenized account associated with the physical commodity holder to another tokenized account;
determining that tokenized account associated with the physical commodity holder does not include fractionalized property tokens for the physical commodity; and
generating a third physical commodity ownership record document removing ownership by the physical commodity holder.

5. The system of claim 4, wherein the operations further comprise: in response to generating a third physical commodity ownership record document removing ownership by the physical commodity holder, purging the fractionalized property tokens corresponding from a circulating supply of fractionalized property tokens.

6. The system of claim 1, wherein generating the second physical commodity ownership record document comprises generating the second physical commodity ownership record document using a machine learning model, wherein the machine learning model is trained to generate physical commodity ownership record documents based on one or more prior physical commodity ownership record documents for the same physical commodity.

7. The system of claim 1, wherein generating the plurality of fractionalized property tokens comprises initiating generation of the plurality of fractionalized property tokens by a group of nodes of a blockchain, wherein the operations further comprise: initiating recordation of the generation of the plurality of fractionalized property tokens onto a distributed ledger of the blockchain, wherein the operations further comprise recording a transfer of the first physical commodity ownership record document from the physical commodity holder to the system on the distributed ledger.

8. The system of claim 1, wherein the physical commodity includes a real estate property, the first physical commodity ownership record document including a digitized deed, and the physical commodity holder including a real estate property owner, and the first physical commodity acquirer including a real estate property purchaser.

9. The system of claim 1, wherein the operations further comprise: performing optical character recognition (OCR) on the first physical commodity ownership record document, and converting data identified from performing the OCR into a standardized format, identifying the value of the physical commodity being based on the converted data.

10. The system of claim 1, wherein the operations further comprise: providing the first physical commodity acquirer with access to the physical commodity.

11. The system of claim 10, the system provides the first physical commodity acquirer with access to the physical commodity by generating a unique access code for a digital lock or security system of the physical commodity.

12. The system of claim 10, the system provides the first physical commodity acquirer with access to the physical commodity by transmitting a signal to one or more Internet of Things (IoT) devices associated with the physical commodity such that the one or more IoT devices grants access to the first physical commodity acquirer.

13. The system of claim 10, the system provides the first physical commodity acquirer with access to the physical commodity by automatically booking the physical commodity for the first physical commodity acquirer for a first tokenized tenure.

14. The system of claim 1, wherein the physical commodity includes a collection of physical properties, wherein the first physical commodity acquirer is able to access one of the physical properties, wherein the tokens represent fractional ownership for the collection of the physical properties, wherein the value of the tokens required for the transfer of ownership is the value of the collection of the physical properties.

15. The system of claim 1, wherein the operations further comprise: receiving a first digital signature from the first physical commodity acquirer and a second digital signature from the physical commodity holder prior to recording a transfer for the first physical commodity ownership record between the first physical commodity holder to the first physical commodity acquirer.

16. The system of claim 1, wherein the at least one processor is configured to apply the first physical commodity ownership record document to a machine learning model, wherein the machine learning model perform the operations of identifying the value of the physical commodity, generating the plurality of fractionalized property tokens corresponding to the value of the physical commodity based on the value and the value for each fractionalized property token, and transmitting the generated fractionalized property tokens to the tokenized account associated with the physical commodity holder.

17. The system of claim 1, wherein the at least one processor is configured to apply the first token resource allocation to a machine learning model, wherein the machine learning model perform the operations of determining a first number of fractionalized property tokens corresponding to the value of the first token resource allocation, transmitting the first number of fractionalized property tokens from the tokenized account associated with the physical commodity holder to the tokenized account associated with the first physical commodity acquirer, and generating a second physical commodity ownership record document indicating fractional ownership by the physical commodity holder and the first physical commodity acquirer.

18. The system of claim 1, the operations further comprising:
receiving a second physical commodity ownership record document for a second physical commodity from the physical commodity holder, wherein generating the plurality of fractionalized property tokens further comprises generating a number of fractionalized property tokens corresponding to the value of the physical commodity and the second physical commodity.

19. The system of claim 1, the operations further comprising:
receiving a second physical commodity ownership record document for a second physical commodity from a second physical commodity holder, wherein generating the plurality of fractionalized property tokens further comprises generating a number of fractionalized property tokens corresponding to the value of the physical commodity and the second physical commodity.

20. A method comprising:
receiving a first physical commodity ownership record document for a physical commodity from a physical commodity holder;
identifying a value of the physical commodity;
generating a plurality of fractionalized property tokens corresponding to the value of the physical commodity based on the value and a value for each fractionalized property token, each fractionalized property token representing a fractional ownership interest in the physical commodity;
transmitting the generated fractionalized property tokens to a tokenized account associated with the physical commodity holder;
receiving a first token resource allocation by a first physical commodity acquirer;
determining a first number of fractionalized property tokens corresponding to the value of the first token resource allocation;
transmitting the first number of fractionalized property tokens from the tokenized account associated with the physical commodity holder to the tokenized account associated with the first physical commodity acquirer; and
generating a second physical commodity ownership record document indicating fractional ownership by the physical commodity holder and the first physical commodity acquirer.

21. A non-transitory computer-readable storage medium storing instructions that, when executed by at least one processor, cause the at least one processor to perform operations comprising:
receiving a first physical commodity ownership record document for a physical commodity from a physical commodity holder;
identifying a value of the physical commodity;
generating a plurality of fractionalized property tokens corresponding to the value of the physical commodity based on the value and a value for each fractionalized property token, each fractionalized property token representing a fractional ownership interest in the physical commodity;
transmitting the generated fractionalized property tokens to a tokenized account associated with the physical commodity holder;
receiving a first token resource allocation by a first physical commodity acquirer;
determining a first number of fractionalized property tokens corresponding to the value of the first token resource allocation;
transmitting the first number of fractionalized property tokens from the tokenized account associated with the physical commodity holder to the tokenized account associated with the first physical commodity acquirer; and
generating a second physical commodity ownership record document indicating fractional ownership by the physical commodity holder and the first physical commodity acquirer.
